(19) United States
(12) Patent Application Publication
(10) Pub. No.: US 2026/0074751 A1
(43) Pub. Date: Mar. 12, 2026

(54) METHOD AND DEVICE FOR HYBRID BEAMFORMER FOR SUPPORTING MULTIPLE NUMEROLOGIES IN WIRELESS COMMUNICATION SYSTEM

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Joosung PARK, Suwon-si (KR); Hyuncheol PARK, Daejeon (KR); Hyunsoo SON, Daejeon (KR)

(21) Appl. No.: 19/387,103

(22) Filed: Nov. 12, 2025

Related U.S. Application Data
(63) Continuation of application No. PCT/KR2024/095714, filed on Apr. 15, 2024.

(30) Foreign Application Priority Data
May 12, 2023 (KR) 10-2023-0061946
May 30, 2023 (KR) 10-2023-0069532

(51) Int. Cl. H04B 7/0456

(52) U.S. Cl. CPC H04B 7/0456

(57) ABSTRACT

The disclosure relates to a 5th generation (5G) or pre-5G communication system for supporting higher data transmission rates than a 4th generation (4G) communication system such as long term evolution (LTE). A method performed by a base station in a wireless communication system is provided. The method includes acquiring, by the base station, channel information from one or more terminals using one or more numerologies, based on the channel information, generating, by the base station, a first precoding matrix for the one or more terminals, based on the first precoding matrix, calculating, by the base station, a first transmission rate, based on the first precoding matrix, calculating, by the base station, first power corresponding to input power of a radio frequency (RF) stage, based on the first power and the channel information, generating, by the base station, a second precoding matrix, based on the second precoding matrix, calculating, by the base station, a second transmission rate, in case that the first transmission rate is greater than or equal to the second transmission rate, generating, by the base station based on the first precoding matrix, a first signal corresponding to signals to be transmitted through multiple antennas of the base station, and transmitting, by the base station, the first signal through the multiple antennas.

### CROSS-REFERENCE TO RELATED APPLICATION(S)

This application is a continuation application, claiming priority under 35 U.S.C. § 365(c), of an International application No. PCT/KR2024/095714, filed on Apr. 15, 2024, which is based on and claims the benefit of a Korean patent application number 10-2023-0061946, filed on May 12, 2023, in the Korean Intellectual Property Office, and of a Korean patent application number 10-2023-0069532, filed on May 30, 2023, in the Korean Intellectual Property Office, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., Ltd. and 2) KOREA ADVANCED INSTITUTE OF SCIENCE AND TECHNOLOGY.

### BACKGROUND

### 1. Field

The disclosure relates to a wireless communication system. More particularly, the disclosure relates to a method and a device for a hybrid beamformer for supporting multiple numerologies in a wireless communication system.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (millimeter wave (mmWave)) bands, (e.g., 60 gigahertz (GHz) bands) so as to accomplish higher data rates. To decrease path loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

In the 5G system, hybrid frequency-shift keying (FSK) and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to improve a beamforming performance through a hybrid beamformer for supporting multiple numerologies in a wireless communication system.

Additional aspects will be set forth in part in the description which follows and, in part, will be apparent from the description, or may be learned by practice of the presented embodiments.

In accordance with an aspect of the disclosure, a method performed by a base station is provided. The method includes acquiring, by the base station, channel information from one or more terminals using one or more numerologies, based on the channel information, generating, by the base station, a first precoding matrix for the one or more terminals, based on the first precoding matrix, calculating, by the base station, a first transmission rate, based on the first precoding matrix, calculating, by the base station, first power corresponding to input power of a radio frequency (RF) stage, based on the first power and the channel information, generating, by the base station, a second precoding matrix, based on the second precoding matrix, calculating, by the base station, a second transmission rate, in case that the first transmission rate is greater than or equal to the second transmission rate, generating, by the base station based on the first precoding matrix, a first signal corresponding to signals to be transmitted through multiple antennas of the base station, and transmitting, by the base station, the first signal through the multiple antennas.

In accordance with another aspect of the disclosure, a base station in a wireless communication system is provided. The base station includes a transceiver, memory, comprising one or more storage media, storing instructions, and at least one processor communicatively coupled to the transceiver and the memory, wherein the instructions, when executed by the at least one processor individually or collectively, cause the base station to acquire channel information from one or more terminals using one or more numerologies, based on the channel information, generate a first precoding matrix for the one or more terminals, based on the first precoding matrix, calculate a first transmission rate, based on the first precoding matrix, calculate first power corresponding to input power of a radio frequency (RF) stage, based on the first power and the channel information, generate a second precoding matrix, based on the second precoding matrix, calculate a second transmission rate, in case that the first transmission rate is greater than or equal to the second transmission rate, generate, based on the first precoding matrix, a first signal corresponding to signals to be transmitted through multiple antennas of the base station, and transmit the first signal through the multiple antennas.

In accordance with another aspect of the disclosure, one or more non-transitory computer-readable storage media storing one or more computer programs including computer-executable instructions that, when executed by one or more processors of a base station individually or collectively, cause the base station to perform operations are provided. The operations include acquiring, by the base station, channel information from one or more terminals using one or more numerologies, based on the channel information, generating, by the base station, a first precoding matrix for the one or more terminals, based on the first precoding matrix, calculating, by the base station, a first transmission rate, based on the first precoding matrix, calculating, by the base station, first power corresponding to input power of a radio frequency (RF) stage, based on the first power and the channel information, generating, by the base station, a second precoding matrix, based on the second precoding matrix, calculating, by the base station, a second transmission rate, in case that the first transmission rate is greater than or equal to the second transmission rate, generating, by the base station based on the first precoding matrix, a first signal corresponding to signals to be transmitted through multiple antennas of the base station, and transmitting, by the base station, the first signal through the multiple antennas.

According to various embodiments of the disclosure, the beamforming performance can be effectively improved through a hybrid beamformer for supporting multiple numerologies in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a multiple input multiple output (MIMO) antenna communication system in a wireless communication system according to an embodiment of the disclosure;

FIG. 2 illustrates a non-overlapping scheme in which frequency resources are allocated without overlapping for different numerologies in a wireless communication system according to an embodiment of the disclosure;

FIG. 3 illustrates a non-overlapping scheme of allocating a guard band in a wireless communication system according to an embodiment of the disclosure;

FIG. 4 illustrates a scheme in which all numerologies supported by a wireless communication system share time and frequency domains according to an embodiment of the disclosure;

FIG. 5 illustrates a hybrid beamforming structure according to a type of hybrid beamforming in a wireless communication system according to an embodiment of the disclosure;

FIG. 6 illustrates a structure of a base station in a wireless communication system according to an embodiment of the disclosure;

FIG. 7 illustrates a structure of a user equipment (UE) in a wireless communication system according to an embodiment of the disclosure;

FIG. 8 illustrates an orthogonal frequency division multiplexing (OFDM) symbols transmitted through a spectrum sharing (SS) multi-numerology system in a wireless communication system according to an embodiment of the disclosure;

FIG. 9 is a block diagram illustrating transmission of a base station supporting different numerologies in a wireless communication system according to an embodiment of the disclosure;

FIG. 10 is a block diagram illustrating transmission of a base station after baseband beamforming in a wireless communication system according to an embodiment of the disclosure;

FIG. 11 is a block diagram illustrating reception between users using different numerologies in a wireless communication system according to an embodiment of the disclosure;

FIG. 12 illustrates interference between users using different numerologies in a wireless communication system according to an embodiment of the disclosure;

FIG. 13 illustrates a hybrid beamforming design in a wireless communication system according to an embodiment of the disclosure;

FIG. 14 is a flowchart illustrating obtaining an initial transmission rate for hybrid beamforming in a wireless communication system according to an embodiment of the disclosure;

FIG. 15 is a flowchart illustrating transmitting a signal, based on a transmission rate in a hybrid beamforming structure in a wireless communication system according to an embodiment of the disclosure;

FIG. 16 is a flowchart illustrating transmitting a signal, based on hybrid beamforming in a wireless communication system according to an embodiment of the disclosure;

FIG. 17 illustrates antenna elements existing based on partially connected hybrid beamforming in a wireless communication system according to an embodiment of the disclosure.

FIG. 18 illustrates a total transmission rate of each user in a clustered delay line-A (CDL-A) channel model in a wireless communication system according to an embodiment of the disclosure;

FIG. 19 illustrates a total transmission rate of the entire system in the CDL-A channel model in a wireless communication system according to an embodiment of the disclosure;

FIG. 20 illustrates a total transmission rate of a user in a clustered delay line-D (CDL-D) channel model in a wireless communication system according to an embodiment of the disclosure; and

FIG. 21 illustrates a total transmission rate of the entire system in the CDL-D channel model in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

In the following description, terms referring to signals (e.g., message, signal, signaling, sequence, and streams), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of descriptive convenience. Therefore, the disclosure is not limited by the terms as described below, and other terms referring to subjects having equivalent technical meanings may be used.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

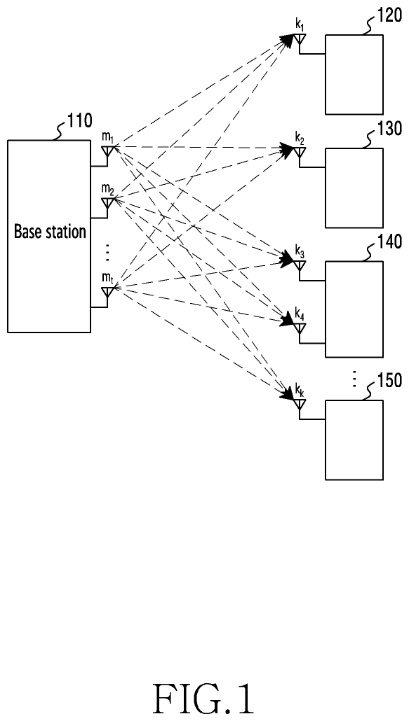

FIG. 1 illustrates a multiple input multiple output (MIMO) antenna communication system in a wireless communication system according to an embodiment of the disclosure.

Referring to FIG. 1, a base station 110 and one or more UEs 120, 130, 140, and 150 are illustrated as part of nodes using a radio channel in a wireless communication system. Although FIG. 1 illustrates only one base station, the wireless communication system may include other base stations that are the same as or similar to the base station 110.

The base station 110 may be a network infrastructure that provides wireless access to the one or more UEs 120, 130, 140, and 150. The base station 110 may have a coverage defined as a predetermined geographic area, based on a distance in which a signal can be transmitted. In addition to the base station, the base station 110 may be referred to as an “access point (AP),” an “eNodeB (eNB),” a “5^{th} generation (5G) node,” a “next generation nodeB (gNB),” a “wireless point,” a “transmission/reception point (TRP),” or other terms having a technical meaning equivalent thereto.

Each of the UEs 120, 130, 140, and 150 is a device used by a user, and performs communication with the base station 110 through a wireless channel. For example, at least one of the UEs 120, 130, 140, and 150 may be operated without a user's intervention. That is, at least one of the UEs 120, 130, 140, and 150 may be a machine type communication (MTC) device and may not be carried by a user. In addition to the terminal, each of the UEs 120, 130, 140, and 150 may be referred to as a “user equipment (UE),” a “mobile station,” a “subscriber station,” a “remote terminal,” a “wireless terminal,” a “user device,” or other terms having a technical meaning equivalent thereto. For example, the UEs 120, 130, and 150 are illustrated as including a single antenna, and the UE 140 is illustrated as including two antennas, but the number of antennas included in each of the UEs 120, 130, 140, and 150 is not limited thereto.

According to an embodiment of the disclosure, the base station 110 may transmit signals for providing a downlink (DL) to the UEs 120, 130, 140, and 150 by using multiple antennas m₁, m₂, . . . , and mₜ. For example, the first UE 120 may receive signals using antenna k₁, the second UE 130 may receive signals using antenna k₂, the third UE 140 may receive signals using antennas k₃ and k₄, and the K^{th} UE 150 may receive signals using antenna k_{K}.

For example, when a signal including data for the first UE 120 is included in a signal transmitted by antenna m1 of the base station 110, the signals transmitted by the other antennas m₂, . . . , and mₜ of the base station 110 may act as interference or noise from the first UE 120's perspective. As another example, a signal for antenna k₄ of the third UE 140 may also act as interference from the perspective of antenna k₃ of the third UE 140.

In case that signals for respective different reception antennas are temporally and spatially separated, the above interference problem may not occur, but the method of temporally or spatially separating the transmitted signals may not be an efficient operating method because only a part of a resource of the base station 110 is used.

According to an embodiment of the disclosure, an orthogonal frequency division multiplexing (OFDM) scheme may be employed to reduce interference between signals transmitted while efficiently using resources in a wireless communication system. The OFDM structure supported in the wireless communication system is called numerology. A specific numerology may be specified by a subcarrier (SC) spacing (SCS) and a cyclic prefix (CP) of a subcarrier. For example, a numerology having a first SCS and a first CP may be defined as a first numerology, and a numerology having a second SCS and a second CP may be defined as a second numerology. A system simultaneously supporting multiple numerologies may be referred to as a multi-numerology system or a mixed-numerology system.

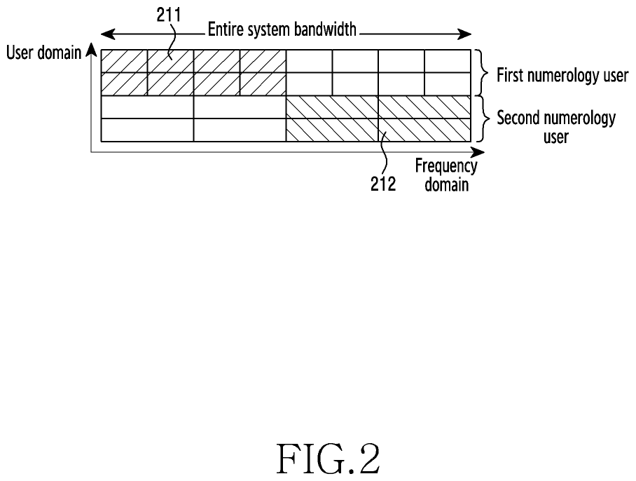

The type of a multi-numerology system may vary depending on whether resources used in the time or frequency domain are overlapped. FIGS. 2 to 4 illustrate resources used in the frequency domain according to the types of multi-numerology systems according to various embodiments.

FIG. 2 illustrates a non-overlapping scheme in which frequency resources are allocated without overlapping for different numerologies in a wireless communication system according to an embodiment of the disclosure.

The non-overlapping may be a scheme of dividing the entire system bandwidth used by the wireless communication system into sub-band units, and allocating each sub-band to users or each numerology. Hereinafter, a “user” may refer to an individual antenna of a UE that receives a signal from the perspective of the base station.

Referring to FIG. 2, each individual box refers to an individual SC of the corresponding numerology. For example, the SCS of the first numerology may be half the SCS of the second numerology. Frequency band 211 for users using the first numerology and frequency band 212 for users using the second numerology may not overlap each other.

Even in a case in which signals of different numerologies do not coexist in the frequency domain by allocating sub-bands according to numerologies in the frequency domain, there may be interference between numerologies due to out-of-band emission (OOBE).

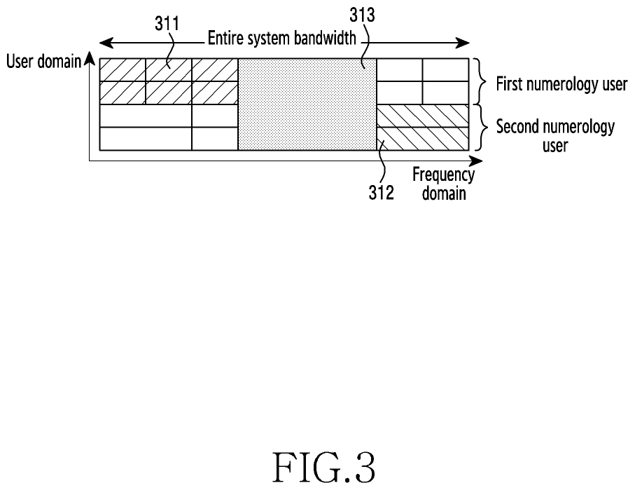

FIG. 3 illustrates a non-overlapping scheme of allocating a guard band in a wireless communication system according to an embodiment of the disclosure.

According to an embodiment of the disclosure, the non-overlapping scheme for allocating a guard band may be a scheme obtained by modifying the non-overlapping scheme of FIG. 2, and a guard band 313 may be allocated between frequency band 311 used by the first numerology and frequency band 312 used by the second numerology, whereby interference due to OOBE can be reduced.

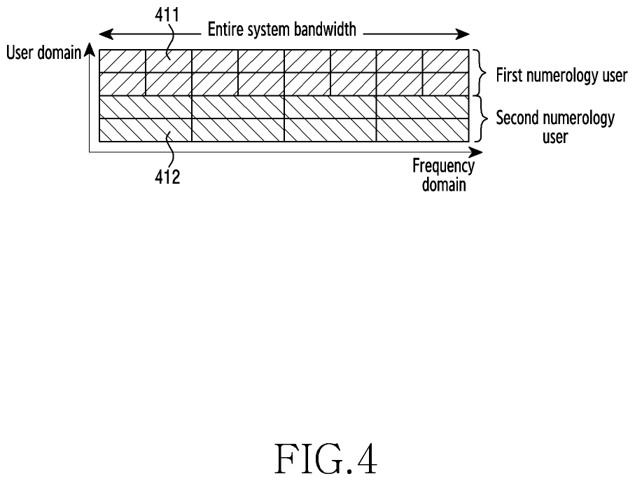

FIG. 4 illustrates a scheme in which all numerologies supported by a wireless communication system share time and frequency domains according to an embodiment of the disclosure.

A spectrum sharing (SS) multi-numerology system may be a scheme in which resources of at least some of numerologies supported by a wireless communication system are overlapped in time and frequency domains. For example, the SS multi-numerology system may be a scheme in which all resources of all numerologies supported by the wireless communication system overlap in time and frequency domains. The SS multi-numerology system may have various types of interference, compared to a wireless communication system supporting a single numerology only. In addition, in the SS multi-numerology system, since all the time and frequency domain resources allowed by the system are used, more complex interference may exist than in the sub-band-based multi-numerology system.

In the SS multi-numerology system, if information is loaded only in some SCs so that the respective numerologies and other numerologies do not overlap in the frequency domain, the SS multi-numerology system may be a subband-based multi-numerology system. Therefore, the concept of the SS multi-numerology system may be a concept that can encompass the entire multi-numerology system.

Hereinafter, a method for reducing interference between transmission and reception signals existing in the SS multi-numerology system will be described. In particular, a zero-forcing (ZF) precoding (in the following, “precoding” may include “ZF precoding”) method for reducing interference between transmission and reception signals will be described in detail.

Before describing a method for reducing interference between transmission and reception signals in the SS multi-numerology system, a wireless communication system through massive MIMO and types of hybrid beamforming for supporting the same are first described.

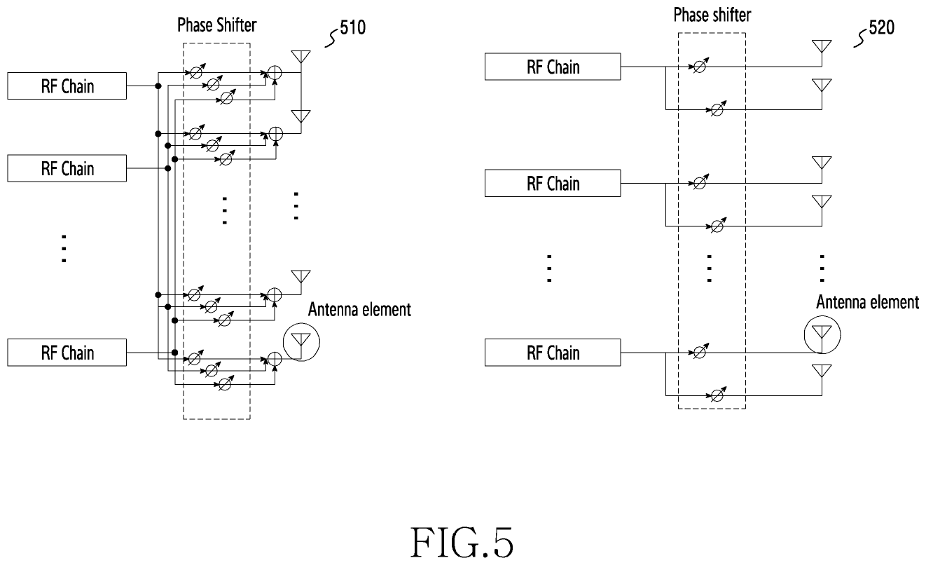

FIG. 5 illustrates a hybrid beamforming structure according to a type of hybrid beamforming in a wireless communication system according to an embodiment of the disclosure.

Referring to FIG. 5, a case in which each of radio frequency (RF) chains is connected to all the antennas as in 510 may be referred to as fully connected hybrid beamforming. In addition, as in 520, the case in which each radio frequency (RF) chain is connected to a part of the antennas rather than all the antennas may be referred to as partially connected hybrid beamforming.

A fully connected hybrid beamforming structure 510 is a structure in which each of the RF chains is connected to all the antennas, and the number of connections may increase in terms of hardware. However, in the hybrid beamforming structure, since each of the RF chains is connected to all the antennas, control for a signal is easy, and a relatively flexible design is possible.

A partially connected hybrid beamforming structure 520 is a structure in which each of the RF chains is connected to a part of the antennas rather than to all of the antennas, and although the hardware connection is reduced, the design freedom is limited by using a small number of RF chains. In a case where the partially connected hybrid beamforming structure is used, when the number of propagation paths constituting the wireless channel between the transmitter and the receiver is limited, a transmission rate close to a transmission rate when the fully connected hybrid beamforming structure is used may be obtained.

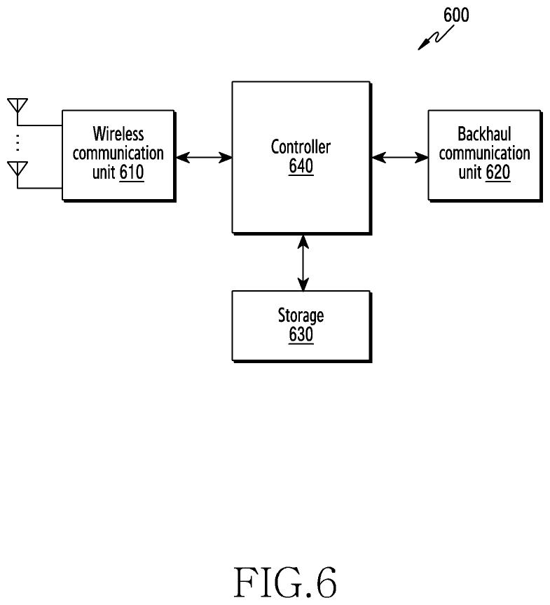

FIG. 6 illustrates a structure of a base station in a wireless communication system according to an embodiment of the disclosure.

The structure of a base station 600 illustrated in FIG. 6 may be understood as a structure of the base station 110 described above with reference to FIG. 1. As used herein, such terms as “ . . . unit“and” . . . er” refer to a unit configured to process at least one function or operation, and may be implemented as hardware, software, or a combination of hardware and software.

Referring to FIG. 6, according to an embodiment of the disclosure, a base station 600 may include a wireless communication unit 610, a backhaul communication unit 620, storage 630, and a controller 640. The base station 600 may be a wireless communication device for communication with UEs.

The wireless communication unit 610 performs functions for transmitting or receiving a signal through a wireless channel. For example, the wireless communication unit 610 may perform functions of conversion between baseband signals and bitstrings according to the physical layer specifications of the system. For example, during data transmission, the wireless communication unit 610 may encode and modulate a transmitted bitstring to generate complex symbols. In addition, during data reception, the wireless communication unit 610 may demodulate and decode a baseband signal to reconstruct a received bitstring.

In addition, the wireless communication unit 610 up-converts a baseband signal to a radio frequency (RF) band signal, transmits the up-converted RF band signal via an antenna, and then down-converts the RF band signal received via the antenna to a baseband signal. To this end, the wireless communication unit 610 may include a transmission filter, a reception filter, an amplifier, a mixer, an oscillator, a digital to analog converter (DAC), an analog to digital converter (ADC), and the like. In addition, the wireless communication unit 610 may include multiple transmission/reception paths.

The wireless communication unit 610 may include a communication module (or package-type module) including at least one antenna array configured by multiple antenna elements. For example, the communication module may further include a field programmable gate array (FPGA). The FPGA may be a semiconductor element including a programmable logic device and a programmable internal line. The programmable logic device may be programmed by duplicating logic gates, such as AND, OR, XOR, and NOT, and more complex decoder functions. The FPGA may further include a flip-flop or memory.

In terms of hardware, the wireless communication unit 610 may include a digital unit and an analog unit, and the analog unit may include multiple sub-units according to operating power, operating frequencies, etc. The digital unit may be implemented by at least one digital signal processor (DSP).

The wireless communication unit 610 may transmit and receive signals as described above. Accordingly, the entirety or a part of the wireless communication unit 610 may be called “a transmitter”, “a receiver”, or “a transceiver”. In addition, as used in the following description, the meaning of “transmission and reception performed through a radio channel” includes the meaning that the above-described processing is performed by the wireless communication unit 610.

The backhaul communication unit 620 provides an interface for performing communication with other nodes in the network. That is, the backhaul communication unit 620 may convert a bitstring, transmitted from the base station 110 to any other node (e.g., any other access node, any other base station, an upper node, or a core network), into a physical signal, and convert a physical signal, received from any other node, into a bitstring.

The storage 630 may store basic programs, application programs, and data, such as configuration information, for operation of the main base station. The storage 630 may include volatile memory, nonvolatile memory, or a combination of volatile memory and nonvolatile memory. In addition, the storage 630 may provide data stored therein at the request of the controller 640.

The controller 640 may control the overall operation of the base station 600. For example, the controller 640 may transmit and receive a signal through the wireless communication unit 610 or the backhaul communication unit 620. The controller 640 records data in the storage 630 and reads the data from the storage 630. The controller 640 may function as a protocol stack required by communication standards. According to another embodiment, the protocol stacks may be included in the wireless communication unit 610. For example, the controller 640 may include at least one processor as a hardware component for performing the above-described functions.

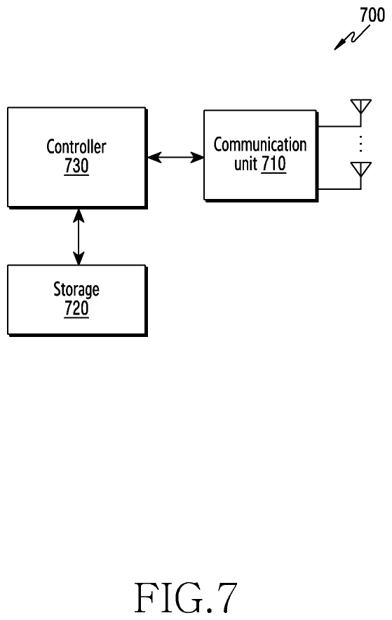

FIG. 7 illustrates a structure of a UE in a wireless communication system according to an embodiment of the disclosure.

The structure of a UE 700 illustrated in FIG. 7 may be understood as a structure of the first UE 120 described above with reference to FIG. 1.

Referring to FIG. 7, according to an embodiment of the disclosure, a UE 700 may include a communication unit 710, storage 720, and/or a controller 730.

The communication unit 710 performs functions for transmitting/receiving signals through radio channels. For example, the communication unit 710 may performs functions of conversion between baseband signals and bitstrings according to the physical layer specifications of the system. For example, during data transmission, the communication unit 710 encodes and modulates a transmitted bitstring to generate complex symbols. In addition, during data reception, the communication unit 710 may demodulate and decode a baseband signal to restore a received bitstring.

In addition, the communication unit 710 may up-convert a baseband signal into an RF band signal and then transmit the converted RF band signal through an antenna, and down-convert an RF band signal received through an antenna into a baseband signal. For example, the communication unit 710 may include a transmission filter, a reception filter, an amplifier, a mixer, an oscillator, a DAC, and an ADC.

In addition, the communication unit 710 may include multiple transmission/reception paths. The communication unit 710 may include at least one antenna array configured by multiple antenna elements. For example, an antenna element may be referred to as an antenna, and an antenna array configured by multiple antenna elements may be understood as including multiple antennas.

In terms of hardware, the communication unit 710 may include a digital circuit and an analog circuit (e.g., radio frequency integrated circuit (RFIC)). For example, the digital circuit and the analog circuit may be implemented as a single package. In addition, the communication unit 710 may include multiple RF chains. The communication unit 710 may perform beamforming.

The communication unit 710 may transmit and receive a signal as described above. Accordingly, all or part of the communication unit 710 may be referred to as a “transmitter”, a “receiver”, or a “transceiver”. In addition, as used in the following description, the meaning of “transmission and reception performed through a radio channel” includes the meaning that the above-described processing is performed by the communication unit 710.

The storage unit D may store basic programs, applicationprograms, and data, such as configuration information, for operation of the main base station. The storage 720 may include volatile memony, nonvolatile memory, or a combination of volatile memoiy and nonvolatile memory. In addition, the storage 720 provides the stored data at the request ofFthe controller 730.

The controller 730 controls the overall operation of the UE 700. For example, the controller 730 may transmit and receive a signal though the communicationunit 710. In addition, the controller 730 records data inthe storage 720 and reads the data from the storage 720. In addition, the controller 730 may perform functions of protocol stacks required by communication specifications. The controller 730 may include at least one processor or micro-processor for performing the above-described functions, or may be a part of a processor. For example, a part of the communication unit 710 and the controller 730 may be referred to as a communication processor (CP).

Hereinafter, terms below will be described using Table 1.

TABLE 1

| | |
|---|---|
| \| Symbol | ⊏ Description |
| └ [symbol] | ┌ Field of real numbers |
| ⊏ [symbol] ₊ | └ Field of non-negative real numbers |
| ┌ [symbol] | ┌Field of complex numbers |
| ⊏\|a\| | \| Absolute value of scalar a |
| ┌ a[m] | ⊏ m^{th} component of vector a |
| └ ∥a∥₂ | ┌ Euclidean norm of vector a |
| ⊏ A | \| Matrix A |
| \| A(m, n) | ⊏ (m, n) component of matrix A |
| └ A(m,:) | ┌ m^{th} row vector of matrix A |
| ┌ A(:, n) | └ n^{th} column vector of matrix A |
| \| A^{T} or a^{T} | \| Transpose of matrix A or vector a |
| ⊏ A^{H} or a^{H} | └ Conjugate transpose of matrix A or vector a |
| └ Tr[A] | ┌ Trace (sum of diagonal components) of matrix A |
| ┌ [symbol] [·] | ┌ Expectation operator |
| \| [symbol] | \| User index |
| \| K | ⊐ Total number of users |
| ┘ mₜ | ┐ Antenna index of base station |
| ⊐ Mₜ | ┘Total number of antennas of base station |
| ⊐ n_{RF} | ⊐ Base station RF chain index |
| ⊐ N_{RF} | \| Number of base station RF chains |
| ┐ μ | ┘ Numerology index |
| ┘ M | ┐Total number of numerologies |
| ⊐ W | \| System bandwidth |
| ┘ Tₛ | $⌊ Sampling period ( {T}_{s} = \frac{1}{W} )$ |
| ⊐ Δfᵤ | ┐ SCS of numerology μ |
| ┐ Nᵤ | $\vert Total number of SCs of numerology μ ( {N}_{μ} = \frac{W}{Δ {f}_{μ}} )$ |
| ┘ ρ | ┐ CP ratio |
| ┐ CP_{μ} | \| CP length of numerology μ (CP_{μ} = ρN_{μ}) |
| ⊐ [symbol] | ┘Set of users using numerology μ |
| ⊐ \| [symbol] \| | ┐ Size of set of users using numerology μ |
| \| α_{c,r,k} | \| Complex path again of r ^{th} ray within c^{th} cluster |
| | of channel between user k and base station |
| ┘ D_{c,r,k} | ┐ Discrete time delay of r ^{th} ray within c^{th} cluster |
| | of channel between user k and base station |
| ⊐ θ_{c,r,k}^{BS} | \| Angle of departure (AoD) of r^{th} ray within c^{th} cluster |
| | of channel between user k and base station |
| ┘ θ̅_{c,k}^{BS} | ┐ Angular spread of rays within c^{th} cluster of channel |
| | between user k and base station |
| ⊐ θ_{c,k} ^{BS} | ┘Mean AoD of rays within c ^{th} |
| | cluster of channel between user k and base station |
| ⊐ [symbol] \tilde{h}_{dk} ∈ | ┐ Wireless channel corresponding to d^{th} time delay tap of channel between user k and base station |
| \| \tilde{H}ₖ ∈ [symbol] | ┐ Channel indicating channel between user k and base station in time-space domain |
| $\begin{matrix}⌉ & {h}_{k}^{( μ , {n}_{μ} )} ∈ \\ {ℂ}^{{M}_{t} \times 1} & \end{matrix}$ | ⊐Spatial-domain channel when channel between user k and base station is represented from n_{μ}^{th} SC perspective |
| $\begin{matrix}⊐ & {H}_{k}^{( μ )} ∈ \\ {ℂ}^{{N}_{μ} \times {M}_{t}} & \end{matrix}$ | ⊏ Frequency-spatial channel matrix when channel between user k and base station is indicated by N_{μ} |
| | $SCs ( {H}_{k}^{( μ )} {=}^{Δ} {[ {h}_{k}^{( μ , 1 )} , {h}_{k}^{( μ , 2 )} , … , {h}_{k}^{( μ , N , μ )} ]}^{T} ∈ {ℂ}^{{N}_{μ} \times {M}_{t}} )$ |
| $\begin{matrix}⌊ & {s}_{{n}_{μ}}^{( μ , n )} ∈ \\ {ℂ}^{K \times 1} & \end{matrix}$ | ┘ Data stream vector of n_{μ} ^{th} SC within n^{th} OFDM symbol of numerology μ |
| $\begin{matrix}⌋ & {f}_{BB , {n}_{μ} , k}^{( μ )} ∈ \\ {ℂ}^{{N}_{RF} \times 1} & \end{matrix}$ | $⌋ Baseband beamforming vector designed to transmit data {s}_{{n}_{μ}}^{( μ , n )} [ k ]$ |
| ┘ F_{RF} ∈ [symbol] | \| As RF BF of base station, matrix in which all components have same magnitude in fully connected HBF structure, and only values |
| | corresponding to part having RF chain and antenna connected |
| | therein have same non-zero value in partially connected structure |
| $\begin{matrix}\vert & {ζ}_{{n}_{μ}}^{( μ , n )} ∈ \\ {ℝ}_{+}^{K \times K} & \end{matrix}$ | \| Diagonal matrix as power normalization factor applied to n_{μ} ^{th} SC within n^{th} OFDM symbol of numerology μ |
| $\begin{matrix}⌉ & {u}_{{n}_{μ}}^{( μ , n )} ∈ \\ {ℂ}^{{N}_{RF} \times 1} & \end{matrix}$ | ⊐ Data stream of n_{μ}^{th} SC within n^{th} OFDM symbol of numerology μ, which has passed through BB BF |
| $\begin{matrix}⌉ & {v}_{{n}_{RF}}^{( μ , n )} ∈ \\ {ℂ}^{{N}_{μ} \times 1} & \end{matrix}$ | ⊐ Signal having passed through BB BF and entering n_{RF}^{th} RF chain of data of n^{th} OFDM symbol of numerology μ |
| $\vert \qquad {p}_{{n}_{μ} , k}^{( μ , n )}$ | ┐ Power of signal allocated to n_{μ}^{th} SC within n ^{th} OFDM symbol of numerology μ for user k |
| \| PBS | ┐ Total transmission power limit of base station over entire |
| | system bandwidth |
| ┘ Zₖ ∈ [symbol] | ┘ Noise vector at user k using numerology μ |

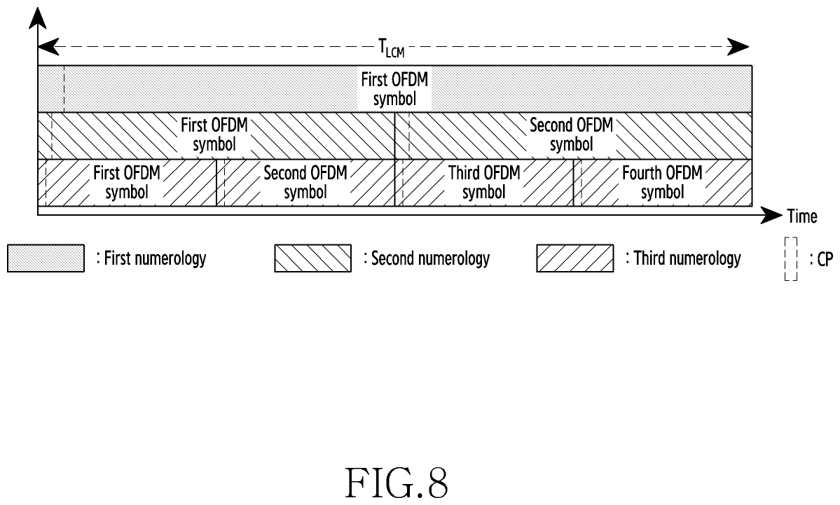

FIG. 8 illustrates OFDM symbols transmitted through an SS multi-numerology system in a wireless communication system according to an embodiment of the disclosure.

Referring to FIG. 8, according to an embodiment of the disclosure, in a wireless communication system operating an SS multi-numerology system, a base station (e.g., the base station 110 of FIG. 6) may include Mₜ antennas. Mₜ may be greater than K which is the total number of users (or reception antennas).

To facilitate a description of the system operation, the index of the numerology having the narrowest SCS among the multiple numerologies is defined as μ=1, and the index of the numerology having the widest SCS is defined as μ=M.

The user index may be given from the user using the numerology having the narrowest SCS (i.e., μ=1). For example, in case that the number of numerologies is 3 and each numerology supports 3 users, K₁={1, 2, 3}, K₂={4, 5, 6}, and K₃={7, 8, 9} may be defined.

The wireless communication system according to an embodiment of the disclosure supports an SS multi-numerology in which all numerologies completely share the entire system bandwidth, and thus all users may have the same sampling cycle and the same CP ratio for all numerologies. With regard to all users, an environment in which time and frequency synchronization is performed may be considered.

Since the number of SCs is different for each numerology, the period of an OFDM symbol may vary according to the numerology. Even if the number of SCs differs for each numerology, the number of SCs of all numerologies is expressed as a power of 2, and thus when the period of an OFDM symbol of the numerology having the narrowest SCS is used, time synchronization may be performed for OFDM symbols of all numerologies.

According to an embodiment of the disclosure, the period of the OFDM symbol of the numerology having the narrowest SCS may be defined as a least common multiplier (LCM) symbol period T_{LCM}. During T_{LCM}, the μ^{th} numerology may transmit or receive

$$\frac{{N}_{1}}{{N}_{μ}}$$

OFDM symbols. For example, when an SCS of a first numerology (μ=1) has a bandwidth of

$${2}^{0} \times \frac{W}{{N}_{1}} ,$$

an SCS of a second numerology (μ=²) has a bandwidth of

$${2}^{1} \times \frac{W}{{N}_{1}} ,$$

and an SCS of a third numerology (μ=³) has a bandwidth of

$${2}^{2} \times \frac{W}{{N}_{1}} ,$$

one OFDM symbol may be transmitted and received in the first numerology, two OFDM symbols may be transmitted and received in the second numerology, and four OFDM symbols may be transmitted and received in the third numerology during T_{LCM}. Here, W may indicate a system bandwidth.

According to an embodiment of the disclosure, T_{LCM} may be calculated based on a total number (N₁) of SCs of the first numerology, the first CP (CP₁), and the sampling period (T_{S}). For example, T_{LCM} may be calculated by Equation 1 below.

$${T}_{LCM} = ( {N}_{1} + {CP}_{1} ) {T}_{S} \qquad Equation 1$$

Since the signals of the numerologies can be synchronized through T_{LCM}, in the SS multi-numerology system, a method for transmitting signals to a user who uses all the numerologies supported by the base station without interference during the may be considered. For example, the base station may consider a technique for removing intra-numerology interference (intra-NI) and inter-numerology interference (inter-NI) in the spatial domain, in order to simultaneously transmit a signal in which all numerology signals are summed through multiple antennas to users. Intra-NI may refer to interference between users using the same numerology, and inter-NI may refer to interference between users using different numerologies.

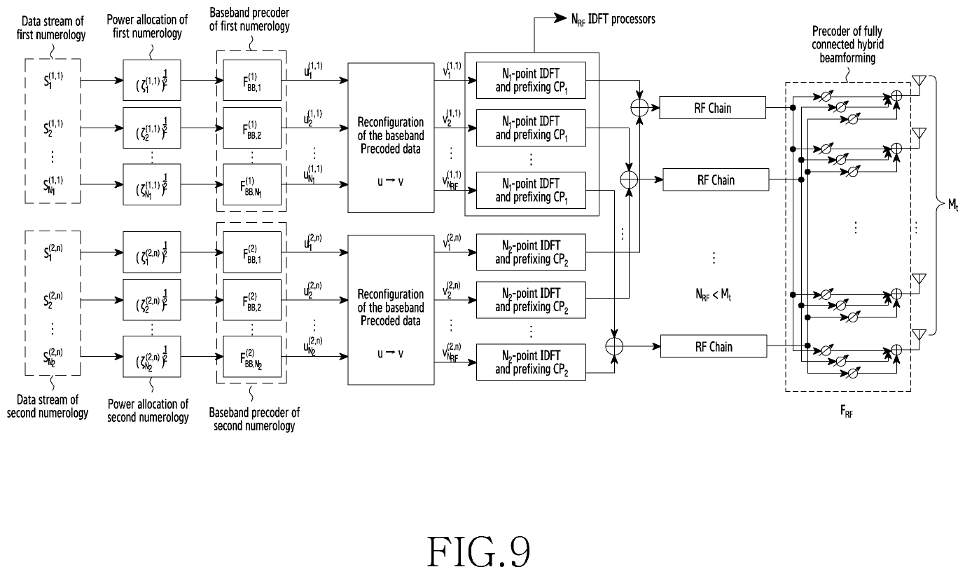

FIG. 9 is a block diagram illustrating transmission of a base station supporting different numerologies in a wireless communication system according to an embodiment of the disclosure.

Referring to FIG. 9, a fully connected hybrid beamforming structure is illustrated, but a partially connected hybrid beamforming structure may also be applied.

$${s}_{{n}_{μ}}^{( μ , n )}$$

may be a data stream f vector of the n_{μ}^{th} SC in the n^{th} OFDM symbol of the μ^{th} numerology, [symbol] may indicate a complex field, and K may indicate a total number of users. The μ^{th} numerology has N_{μ} SCs, and

$$\frac{{N}_{1}}{{N}_{μ}}$$

OFDM symbols may be transmitted or received during T_{LCM} so that

$${s}_{{n}_{μ}}^{( μ , n )}$$

may be defined for

$$1 \leq n \leq \frac{{N}_{1}}{{N}_{μ}} and 1 \leq {n}_{μ} \leq {N}_{μ} .$$

In addition, if Gaussian signaling is assumed,

$${s}_{{n}_{μ}}^{( μ , n )} [ k ]$$

may be expressed as in Equation 2 below.

$${s}_{{n}_{μ}}^{( μ , n )} [ k ] = \{ \begin{matrix}random variable \sim 𝒞𝒩 ( 0 , 1 ) , & for k ∈ {𝒦}_{μ} \\ 0 , & otherwise\end{matrix} \qquad Equation 2$$

In Equation 2, a random variable may indicate a value of data to be transmitted, [symbol] (0,1) may indicate a complex normal distribution (or complex Gaussian distribution) having a mean of 0 and a variance of 1, a˜b may indicate that random variable a follows probability distribution b, and [symbol] may indicate a set of users using numerology μ.

In order to allocate a power of

$${p}_{{n}_{μ} , k}^{( μ , n )} to {s}_{{n}_{μ}}^{( μ , n )} [ k ] ,$$

the k^{th} diagonal component of the power allocation diagonal matrix

$${ζ}_{{n}_{μ}}^{( μ , n )}$$

may be expressed as in Equation 3 below.

$${ζ}_{{n}_{μ}}^{( μ , n )} ( k , k ) {=}^{△} {ζ}_{{n}_{μ} , k}^{( μ , n )} = \frac{{N}_{μ} {T}_{s}}{{‖ {F}_{RF} {f}_{BB , {n}_{μ} , k}^{( μ )} ‖}_{2}^{2}} {p}_{{n}_{μ} , k}^{( μ , n )} \qquad Equation 3$$

In Equation 3, F_{RF} may represent an RF beamformer (or an RF beamforming vector),

$${f}_{BB , {n}_{μ} , k}^{( μ )}$$

may represent a baseband (BB) beamformer (or a baseband beamforming vector) for the n_{μ}^{th} SC of user k of the μ^{th} numerology, N_{μ} may represent the total number of SCs of numerology μ(

$$( {N}_{μ} = \frac{W}{Δ {f}_{μ}} ) ,$$

where W is the system bandwidth, and Δf_{μ} is the SCS of numerology μ), Tₛ may represent the sampling period

$$( {T}_{s} = \frac{1}{W} ) ,$$

where W is the system bandwidth),

$${p}_{{n}_{μ} , k}^{( μ , n )}$$

may represent the signal power allocated to the n_{μ}^{th} SC within the n^{th} OFDM symbol of user k of numerology μ, and ∥a∥₂ may represent a Euclidean norm of vector a.

The reason for defining in Equation 3 that

$${f}_{BB , {n}_{μ} , k}^{( μ )}$$

is irrespective of the OFDM symbol index is to assume that the coherence time of a radio channel is longer than T_{LCM}.

In Equation 3, if user k is not a user of numerology μ,

$${ζ}_{{n}_{μ}}^{( μ , n )} ( k , k ) = 0$$

may be defined.

If a fully connected hybrid beamforming structure is assumed, the magnitude of all the elements of F_{RF} may be equal to

$$\frac{1}{\sqrt{{M}_{t}}}$$

(Mₜ is the total number of antennas of the base station). F_{RF} may be expressed as in Equation 4 below.

$$\vert {F}_{RF} ( i , j ) \vert = \frac{1}{\sqrt{{M}_{t}}} , ∀ ( i , j ) \qquad Equation 4$$

In Equation 4, Mₜ may indicate the total number of base station antennas.

The transmission power of base station over the entire system bandwidth may be limited to P_{BS}, and in order to satisfy the transmission power limit, the following Equation 5 may need to be satisfied.

$${\sum }_{μ = 1}^{M} [ \frac{{N}_{μ}}{{N}_{1}} {\sum }_{n = 1}^{{N}_{1} / {N}_{μ}} {\sum }_{{n}_{μ} = 1}^{{N}_{μ}} {\sum }_{k ∈ {𝒦}_{μ}} {p}_{{n}_{μ} , k}^{( μ , n )} ] \leq {P}_{BS} \qquad Equation 5$$

In Equation 5, M may represent the total number of numerologies, N_{μ} may represent the total number of SCs of numerology μ, [symbol] may represent a user set using numerology μ, and

$${p}_{{n}_{μ} , k}^{( μ , n )}$$

may represent signal power allocated to the n_{μ}^{th} SC of the n^{th} OFDM symbol of user k using numerology μ.

The data

$${u}_{{n}_{μ}}^{( μ , n )}$$

on the n_{μ}^{th} SC of the n^{th} OFDM symbol of numerology μ beamformed by the baseband beamformer for each subcarrier may be expressed as in Equation 6 below.

$${u}_{{n}_{μ}}^{( μ , n )} = {{F}_{BB , {n}_{μ}}^{( μ )} ( {ζ}_{{n}_{μ}}^{( μ , n )} )}^{\frac{1}{2}} {s}_{{n}_{μ}}^{( μ , n )} = {\sum }_{k ∈ {𝒦}_{μ}} \frac{{f}_{BB , {n}_{μ} , k}^{( μ )}}{{‖ {F}_{RF} {f}_{BB , {n}_{μ} , k}^{( μ )} ‖}_{2}} \sqrt{{p}_{{n}_{μ} , k}^{( μ , n )} {N}_{μ} {T}_{s}} {s}_{{n}_{μ}}^{( μ , n )} [ k ] ∈ {ℂ}^{{N}_{RF \times 1}} \qquad Equation 6$$

In Equation 6,

$${ζ}_{{n}_{μ}}^{( μ , n )}$$

may indicate a diagonal matrix as a power normalization factor applied to the n_{μ}^{th} SC in the n^{th} OFDM symbol of numerology μ,

$${s}_{{n}_{μ}}^{( μ , n )}$$

may indicate a data stream vector of the n_{μ}^{th} SC in the n^{th} OFDM symbol of numerology μ, Tₛ may indicate a sampling period, [symbol] may indicate a complex field, and N_{RF} may indicate the number of RF chains of the base station.

The

$${F}_{BB , {n}_{μ}}^{( μ )}$$

in Equation 6 may be expressed as in Equation 7 below.

$${F}_{BB , {n}_{μ}}^{( μ )} = [ {f}_{BB , {n}_{μ} , 1}^{( μ )} , {f}_{BB , {n}_{μ} , 2}^{( μ )} , … , {f}_{BB , {n}_{μ} , K}^{( μ )} ] ∈ {ℂ}^{{N}_{RF} \times K} . \qquad Equation 7$$

In Equation 7,

$${f}_{BB , {n}_{μ} , K}^{( μ )}$$

may indicate a baseband beamformer for the n_{μ}^{th}SC of user k of numerology μ, [symbol] may indicate a complex field, N_{RF} may indicate the number of RF chains of the base station, and K may indicate a total number of users.

The meaning of Equation 7 may be interpreted as beamforming performed for each subcarrier. Thereafter, in order to perform an IDFT and RF beamforming for each RF chain, a signal having passed through the baseband beamformer is reconfigured for each RF chain. The signal

$${v}_{{n}_{RF}}^{( μ , n )}$$

passed through the baseband beamformer to be input to the n_{RF}^{th} RF chain may be expressed as in Equation 8 below.

$${v}_{{n}_{RF}}^{( μ , n )} {=}^{Δ} {[ {u}_{1}^{( μ , n )} [ {n}_{RF} ] , {u}_{2}^{( μ , n )} [ {n}_{RF} ] , … , {u}_{{N}_{μ}}^{( μ , n )} [ {n}_{RF} ] ]}^{T} ∈ {ℂ}^{{N}_{μ} \times 1} \qquad Equation 8$$

In Equation 8,

$${u}_{{n}_{μ}}^{( μ , n )}$$

may represent a data stream of the n_{μ}^{th} SC in the n^{th} OFDM symbol of numerology p having passed through the baseband beamformer, n_{RF} may represent an index of the RF chain of the base station, [symbol] may represent a complex field, and N, may represent the total number of SCs of numerology μ.

Thereafter, the base station may add the N_{μ}-point IDFT and the CP to each

$${v}_{{n}_{RF}}^{( μ , n )} ,$$

and may sum signals of all numerologies in the time domain. The signals all combined in the time domain may undergo a signal processing process by F_{RF} after passing through the RF chain. Finally, the signal may be emitted through the transmission antenna of the base station.

The \tilde{X}^{(μ,n)} corresponding to the signal of the n^{th} OFDM symbol of the μ^{th} numerology, which is emitted through the base station transmission antenna, may be expressed in the spatial-time domain as in Equation 9 below.

$${\tilde{X}}^{( μ , n )} = {{F}_{RF} ( {V}^{( μ , n )} )}^{T} {{T}_{{N}_{μ}}^{H} [ \begin{matrix}{0}_{{CP}_{μ} \times ( {N}_{μ} - {CP}_{μ} )} , {I}_{{CP}_{μ}} \\ {I}_{{N}_{μ}}\end{matrix} ]}^{T} ∈ {ℂ}^{{M}_{t} \times ( 1 + ρ ) {N}_{μ}} \qquad Equation 9$$

In Equation 9, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${T}_{{N}_{μ}}^{H}$$

may indicate an N_{μ}-point IDFT unitary matrix (where Tr[A] may indicate the trace (sum of diagonal components) of matrix A), A^{H} may indicate the conjugate transpose of matrix A, and A^{T} may indicate the transpose of matrix A. N_{μ} may indicate the total number of SCs of numerology μ, CP_{μ} may indicate the CP length (CP_{μ}=ρN_{μ}) of numerology μ, ρ may indicate a CP ratio, I may indicate a unit matrix, [symbol] may indicate a complex field, and Mₜ may indicate the total number of antennas of the base station

The V^{(μ,n)} in Equation 9 may be expressed as in Equation 10 below

$${V}^{( μ , n )} {=}^{Δ} [ {v}_{1}^{( μ , n )} , {v}_{2}^{( μ , n )} , … , {v}_{{N}_{RF}}^{( μ , n )} ] ∈ {ℂ}^{{N}_{μ} \times {N}_{RF}} \qquad Equation 10$$

$${v}_{{n}_{RF}}^{( μ , n )}$$

may indicate a signal entering the n_{RF}^{th} RF chain among data of the n^{th} OFDM symbol of numerology p that has passed through the baseband beamformer, n_{RF} may indicate an RF chain index of the base station, [symbol] may indicate a complex field, N_{μ} may indicate the total number of SCs of numerology μ, and N_{RF} may indicate the number of RF chains of the base station.

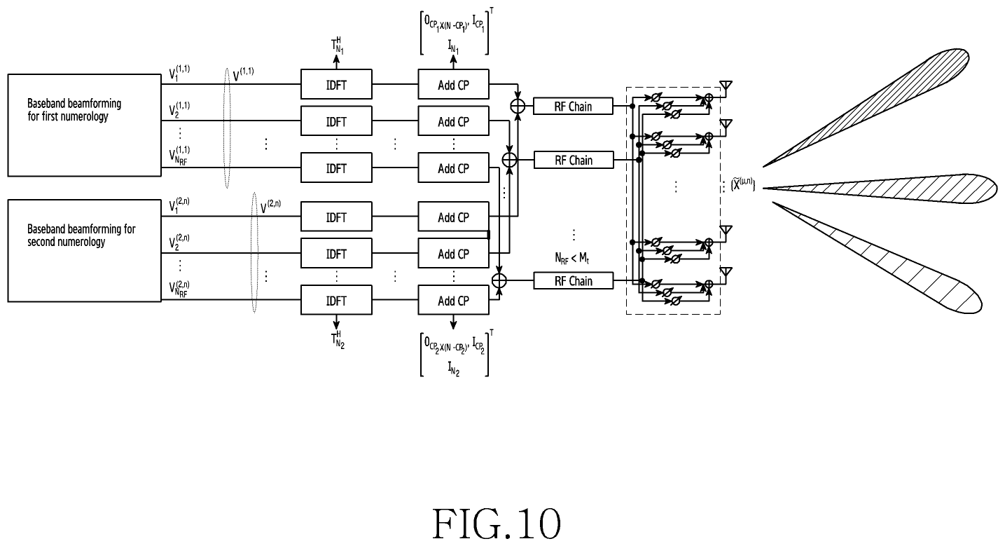

FIG. 10 is a block diagram illustrating transmission of a base station after baseband beamforming in a wireless communication system according to an embodiment of the disclosure.

Referring to FIG. 10, if the number of clusters of a scatterer is limited, channel \tilde{h}_{d,k} corresponding to the d^{th} delay tap of a channel between user k and the base station according to the delay-d channel model may be expressed as in Equation 11 below.

$${\tilde{h}}_{d , k} = \sqrt{\frac{{M}_{t}}{{N}_{CL , k} {N}_{ray , k}}} \text{} {\sum }_{c = 1}^{{N}_{CL , k}} {\sum }_{r = 1}^{{N}_{ray , k}} {α}_{c , r , k} {δ ( d - {D}_{c , r , k} ) [ {a}_{BS} ( {θ}_{c , r , k}^{BS} ) ]}^{H} ∈ {ℂ}^{1 \times {M}_{t}} \qquad Equation 11$$

In Equation 11, Mₜ may indicate the total number of base station antennas, N_{CL,k} may indicate the number of scatterer clusters in the channel to user k, N_{ray,k} may indicate the number of rays per cluster, α_{c,r,k} may indicate a complex path gain of the r^{th} ray in the c^{th} cluster of the channel between user k and the base station, D_{c,r,k} may indicate a discrete time delay of the r^{th} ray in the c^{th} cluster of the channel between user k and the base station,

$${a}_{BS} ( {θ}_{c , r , k}^{BS} )$$

may indicate an antenna array response of the base station antenna array when the angle of departure is

$${θ}_{c , r , k}^{BS} , {θ}_{c , r , k}^{BS}$$

may indicate the angle of departure (AoD) of the r^{th} ray in the c^{th} cluster of the channel between user k and the base station, A^{H} may indicate a conjugate transpose of matrix A, and [symbol] may indicate a complex field.

In Equation 11, if it is assumed that a uniform linear array (ULA) type of antenna array is used, one AoD may exist for each path. However, it is also possible to expand to the case of having a uniform planar array (UPA) type of antenna array, in which three-dimensional beamforming is possible by a base station. In the case of having the UPA type of antenna array, the Kronecker product may be performed for the antenna array responses according to each axis of the antenna array to configure the antenna array response in a vector form.

In Equation 11, the Equation 12 expressed below may need to be satisfied in order to for D_{c,r,k} to satisfy the avoidance condition.

$$0 \leq {D}_{c , r , k} \leq C {P}_{μ} \qquad Equation 12$$

In Equation 12, D_{c,r,k} may indicate the discrete time delay of the r^{th} ray in the c^{th} cluster of a channel between user k and the base station, and CP, may indicate the CP length of numerology μ.

In addition, layers in the same cluster may be located close to each other, and thus different layers in the same cluster may cause the same time delay as in the cluster-delay-line (CDL) channel model. This may be expressed as Equation 13 below.

$${D}_{c , 1 , k} = {D}_{c , 2 , k} = … = {D}_{c , {N}_{r a y , k} , k} {=}^{△} {D}_{c , k} \qquad Equation 13$$

In Equation 13, D_{c,r,k} may indicate the discrete time delay of the r^{th} ray in the c^{th} cluster of a channel between user k and the base station.

The channel \tilde{H} between user k and the base station in the time-spatial domain in Equation 11 may be expressed as a matrix as in Equation 14 below.

$${\tilde{H}}_{k} {=}^{△} {[ {( {\tilde{h}}_{0 , k} )}^{T} , {( {\tilde{h}}_{1 , k} )}^{T} , … , {( {\tilde{h}}_{C {P}_{μ} , k} )}^{T} ]}^{T} ∈ {ℂ}^{( C {P}_{μ} + 1 ) \times {M}_{t}} \qquad Equation 14$$

In Equation 14, \tilde{h}_{d,k} may indicate a wireless channel corresponding to the d^{th} time delay tap in a channel between user k and the base station, A^{T} may indicate a transpose of matrix A, [symbol] may indicate a complex field, CP_{μ} may indicate a CP length of numerology μ, and Mₜ may indicate a total number of base station antennas.

The channel \tilde{H}ₖ between user k and a base station in the time-spatial domain in Equation 11 may be expressed as in Equation 15 below.

$$Equation 15$$

$${\tilde{H}}_{k} = {γ}_{k} [ \begin{matrix}δ ( - {D}_{1 , k} ) & δ ( - {D}_{2 , k} ) & & δ ( - {D}_{{N}_{CL , k} , k} ) \\ δ ( 1 - {D}_{1 , k} ) & δ ( 1 - {D}_{2 , k} ) & … & δ ( 1 - {D}_{{N}_{CL , k} , k} ) \\ ⋮ & ⋮ & & ⋮ \\ δ ( {CP}_{μ} - {D}_{1 , k} ) & δ ( {CP}_{μ} - {D}_{2 , k} ) & & δ ( {CP}_{μ} - {D}_{{N}_{CL , k} , k} )\end{matrix} ] [ \begin{matrix}{\sum }_{r = 1}^{{N}_{ray , k}} {{α}_{1 , r , k} [ {a}_{BS} ( {θ}_{1 , r , k}^{BS} ) ]}^{H} \\ {\sum }_{r = 1}^{{N}_{ray , k}} {{α}_{2 , r , k} [ {a}_{BS} ( {θ}_{2 , r , k}^{BS} ) ]}^{H} \\ ⋮ \\ {\sum }_{r = 1}^{{N}_{ray , k}} {{α}_{{N}_{CL , k} , r , k} [ {a}_{BS} ( {θ}_{{N}_{CL , k} , r , k}^{BS} ) ]}^{H}\end{matrix} ]$$

In Equation 15, D_{c,k} may indicate the discrete time delay in the c^{th} cluster of a channel between user k and the base station, CP_{μ} may indicate the CP length of the μ^{th} numerology, N_{ray,k} may indicate the number of rays per cluster, α_{c,r,k} may indicate the complex path gain of the r^{th} ray in the c^{th} cluster of the channel between user k and the base station,

$${a}_{BS} ( {θ}_{c , r , k}^{B S} )$$

may indicate the antenna array response of the base station antenna array when the angle of departure is

$${θ}_{c , r , k}^{B S} , {θ}_{c , r , k}^{BS}$$

may indicate the angle of departure the r^{th} ray in the c^{th} cluster of the channel between user k and the base station, and A^{H} may indicate the conjugate transpose of matrix A.

In Equation 15, γₖ may be expressed as in Equation 16 below.

$${γ}_{k} = \sqrt{\frac{{M}_{t}}{{N}_{CL , k} {N}_{ray , k}}} \qquad Equation 16$$

In Equation 16, Mₜ may indicate a total number of base station antennas, N_{CL,k} may indicate a number of scatterer clusters in a channel to user k, and N_{ray,k} may indicate a number of rays per cluster.

In Equation 11, the channel

$${H}_{k}^{( μ )}$$

between user k and the base station in the frequency-spatial domain may be expressed as a matrix, as in Equation 17 below.

$${H}_{k}^{( μ )} = {[ {h}_{k}^{( μ , 1 )} , {h}_{k}^{( μ , 2 )} , … , {h}_{k}^{( μ , {N}_{μ} )} ]}^{T} ∈ {ℂ}^{{N}_{μ} \times {M}_{t}} \qquad Equation 17$$

In Equation 17,

$${h}_{k}^{( μ , {n}_{μ} )}$$

may indicate a spatial domain channel when the channel between user k and the base station is expressed from the perspective of the n_{μ}^{th} SC, N_{μ} may indicate total number of SCs of numerology μ, A^{T} may indicate a transpose of matrix A, [symbol] may indicate a complex field, and Mₜ may indicate the total number of antennas of the base station.

In Equation 17,

$${h}_{k}^{( μ , {n}_{μ} )}$$

may be expressed as in Equation 18 below.

$${h}_{k}^{( μ , {n}_{μ} )} = {\sqrt{{N}_{μ}} [ \begin{matrix}{\tilde{H}}_{k} \\ {0}_{( {N}_{μ} - ( C {P}_{μ} + 1 ) ) \times {M}_{t}}\end{matrix} ]}^{T} {T}_{{N}_{μ}} ( : , {n}_{μ} ) ∈ {ℂ}^{{M}_{t} \times 1} \qquad Equation 18$$

In Equation 18, N_{μ} may indicate the total number of SCs of numerology μ, \tilde{H}ₖ may indicate the channel between user k and the base station in the time-spatial domain, CP may indicate the CP length of numerology μ, Mₜ may indicate the total number of antennas of the base station, A^{T} may indicate the transpose of matrix A, T_{N}_{_{μ}} may indicate an N_{μ}-point DFT unitary matrix, and [symbol] may indicate a complex field.

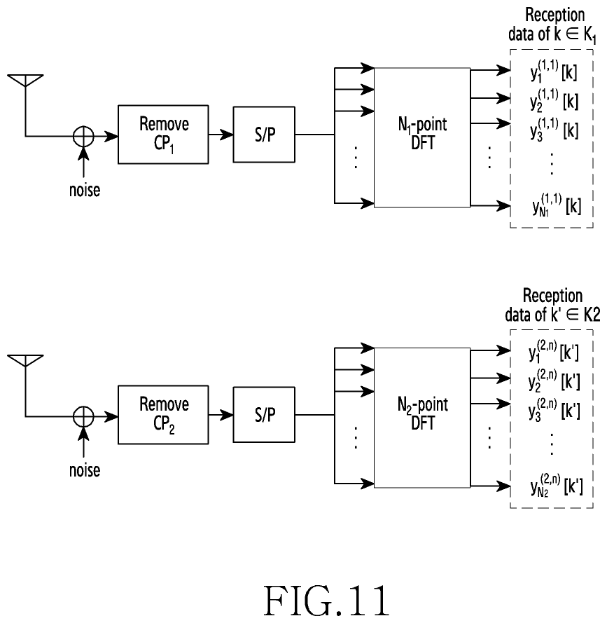

FIG. 11 is a block diagram illustrating reception between users using different numerologies in a wireless communication system according to an embodiment of the disclosure.

Referring to FIG. 11, each user may process a signal by adding noise thereto. Referring to FIG. 11, it is understood that additive white Gaussian noise (AWGN) is added to the reception antennas of the respective users. As the AWGN is added to the reception antenna of each user, each user may receive a signal to which the AWGN is added. A user having received the signal to which the AWGN has been added may remove a CP having a length corresponding to the numerology used by each user. After each user removes the CP, each user may perform DFT on the signal from which the CP has been removed to restore the signal in the frequency domain.

User k using numerology μ may receive

$$\frac{{N}_{1}}{{N}_{μ}}$$

OFDM symbols during T_{LCM}. N_{μ} may be the total number of SCs of numerology μ. Each received OFDM symbol may be expressed as a sum of a desired signal, intra-NI, inter-NI, and AWGN.

Among the signal components for the n_{μ}^{th} SC data of the n^{th} OFDM symbol of user k using numerology μ, the desired signal d^{(k,μ,n)}[n_{μ}] may be expressed as in Equation 19 below.

$${d}^{( k , μ , n )} [ {n}_{μ} ] = \underbrace{{( {h}_{k}^{( μ , {n}_{μ} )} )}^{T} {F}_{R F}}_{= {( {\hat{h}}_{k}^{( μ , {n}_{μ} )} )}^{T}} {f}_{B B , {n}_{μ} , k}^{( μ )} \sqrt{{ζ}_{{n}_{μ} , k}^{( μ , n )}} {s}_{{n}_{μ}}^{( μ , n )} [ k ] \qquad Equation 19$$

In Equation 19,

$${h}_{k}^{( μ , {n}_{μ} )}$$

may indicate a spatial domain channel when a channel between user k and the base station is expressed from the viewpoint of the n_{μ}^{th}SC, A^{T} may indicate a transpose of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${f}_{BB , {n}_{μ} , k}^{( μ )}$$

may indicate a baseband beamformer for the n_{μ}^{th} SC of user k of the μ^{th} numerology,

$${ζ}_{{n}_{μ} , k}^{( μ , n )}$$

may indicate a diagonal matrix as a power normalization factor applied to the n_{μ}^{th} SC in the n^{th} OFDM symbol of the μ^{th} numerology,

$${s}_{{n}_{μ}}^{( μ , n )}$$

may indicate a data stream vector of the n_{μ}^{th} SC in the n^{th} OFDM symbol of the μ^{th} numerology, and a[m] may indicate the m^{th} component of vector a.

In Equation 19,

$${( {h}_{k}^{( μ , {n}_{μ} )} )}^{T}$$

F_{RF} may indicate

$${( {\hat{h}}_{k}^{( μ , {n}_{μ} )} )}^{T} .$$

Among the respective signal components for the n_{μ}^{th} SC data of the n^{th} OFDM symbol of user k using the μ^{th} numerology, for the intra-NI,

$${\overline{\overline{ι n ι}}}_{{k}^{′}}^{( k , μ , n )} [ {n}_{μ} ]$$

may be expressed as in Equation 20 below.

$${\overline{\overline{ι n ι}}}_{{k}^{′}}^{( k , μ , n )} [ {n}_{μ} ] = {\underbrace{{( {h}_{k}^{( μ , {n}_{μ} )} )}^{T} {F}_{RF}}}_{= {( {\hat{h}}_{k}^{( μ , {n}_{μ} )} )}^{T}} {f}_{BB , {n}_{μ} , {k}^{′}}^{( μ )} \sqrt{{ζ}_{{n}_{μ} , {k}^{′} <}^{( μ , n )}} {s}_{{n}_{μ}}^{( μ , n )} [ {k}^{′} ] \qquad Equation 20$$

$${h}_{k}^{( μ , {n}_{μ} )}$$

may indicate the spatial domain channel when the channel between user k and the base station is expressed from the perspective of the n_{μ}^{th} SC A^{T} may indicate the transpose of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${f}_{BB , {n}_{μ} , k}^{( μ )}$$

may indicate the baseband beamformer of the n_{μ}^{th} SC ofuser k′ for numerology

$$μ , {ζ}_{{n}_{μ}}^{( μ , n )}$$

may indicate a diagonal matrix as a power normalization factor applied to the n_{μ}^{th} SC in the n^{th} OFDM symbol of user k′ for numerology μ,

$${s}_{{n}_{μ}}^{( μ , n )}$$

may indicate the data stream vector of the n_{μ}^{th} SC in the n^{th} OFDM symbol for numerology μ, and a[m] may indicate the m^{th} component of vector a.

In Equation 20,

$${( {h}_{k}^{( μ , {n}_{μ} )} )}^{T}$$

F_{RF} may indicate

$${( {\hat{h}}_{k}^{( μ , {n}_{μ} )} )}^{T} .$$

The inter-NI received from the n′^{th} OFDM symbol of numerology μ′ different from that of user k may be differently modeled according to the magnitude relation of the SCSs of the two numerologies.

In addition, the n^{th} OFDM symbol of numerology μ may receive interference only when the symbol index of the OFDM symbol of numerology μ′ satisfies Equation 21 expressed below.

$$⌊ \frac{( n - 1 ) {N}_{μ}}{{N}_{μ}} ⌋ + 1 \leq {n}^{′} \leq ⌈ \frac{{nN}_{μ}}{{N}_{{μ}^{′}}} ⌉ \qquad Equation 21$$

In Equation 21, N_{μ} may indicate the total number of SCs of numerology μ, and N_{μ′} may indicate the total number of SCs of numerology μ′.

According to an embodiment of the disclosure, when the SCS of the numerology that acts as interference is narrower than the SCS of the numerology used by user k (i.e., μ′<μ), the inter-NI received from the n′^{th} OFDM symbol of numerology μ′ by the n_{μ}^{th} SC data of the n^{th} OFDM symbol of user k using numerology μ may be expressed as in Equation 22 below.

$${{μ}^{′} , {n}^{′}}_{( k , μ , n )}^{} [ {n}_{μ} ] = {\sum }_{{n}_{{μ}^{′}} = 1}^{{N}_{{μ}^{′}}} {T}_{{N}_{μ}} ( {n}_{μ} , : ) {M}_{{μ}^{′}}^{( μ , {β}_{1} )} ( : , {n}_{{μ}^{′}} ) {\underbrace{{( {h}_{k}^{( {μ}^{′} , {n}_{{μ}^{′}} )} )}^{T} {F}_{RF}}}_{= {( {\hat{h}}_{k}^{( {μ}^{′} , {n}_{{μ}^{′}} )} )}^{T}} {{F}_{BB , {n}_{{μ}^{′}}}^{( {μ}^{′} )} ( {ζ}_{{n}_{{μ}^{′}}}^{( {μ}^{′} , {n}^{′} )} )}^{\frac{1}{2}} {s}_{{n}_{{μ}^{′}}}^{( {μ}^{′} , {n}^{′} )} \qquad Equation 22$$

In Equation 22, N_{μ′} may indicate the total number of SCs of numerology μ′, T_{N}_{_{μ}}(n_{μ},:) may indicate the n_{μ}^{th} row vector of T_{N}_{_{μ}}, T_{N}_{_{μ}} may indicate a N_{μ}-point DFT unitary matrix,

$${M}_{{μ}^{′}}^{( μ , {β}_{1} )}$$

(:, n_{μ′}) may indicate the n_{μ′}^{th} column vector of

$${M}_{{μ}^{′}}^{( μ , {β}_{1} )} ,$$

β₁ may indicate the relative location of the n^{th} OFDM symbol of numerology μ from the perspective of the n′^{th} OFDM symbol of numerology μ′ in the time domain,

$${h}_{k}^{( {μ}^{′} , {n}_{μ}^{′} )}$$

may indicate the spatial domain channel when the channel between user k and the base station is expressed from the perspective of the n_{μ′}^{th} SC A^{T} may indicate the transpose of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${ζ}_{{n}_{μ}^{′}}^{( {μ}^{′} , {n}^{′} )}$$

may indicate a diagonal matrix as a power normalization factor applied to the n_{μ′}^{th} SC in the n′^{th} OFDM symbol of numerology

$${μ}^{′} , {s}_{{n}_{μ}^{′}}^{( {μ}^{′} , {n}^{′} )}$$

may indicate the data stream vector of the n_{μ′}^{th} SC in the n′^{th} OFDM symbol of numerology μ′, and a[m] may indicate the m^{th} component of vector a.

### In Equation 22,

$${( {h}_{k}^{( {μ}^{′} , {n}_{μ}^{′} )} )}^{T}$$

F_{RF} may indicate

$${( {\hat{h}}_{k}^{( {μ}^{′} , {n}_{μ}^{′} )} )}^{T}$$

In Equation 22, β₁ may be expressed as in Equation 23 below.

$${β}_{1} {=}^{△} mod ( n , \frac{{N}_{μ}^{′}}{{N}_{μ}} ) + \frac{{N}_{μ}^{′}}{{N}_{μ}} δ ( mod ( n , \frac{{N}_{μ}^{′}}{{N}_{μ}} ) ) \qquad Equation 23$$

In Equation 23, N_{μ} may indicate the total number of SCs of numerology μ, and N_{μ′}, may indicate the total number of SCs of numerology μ′.

In Equation 22,

$${F}_{BB , {n}_{μ}}^{( μ )}$$

may be expressed as in Equation 7 described above.

$${F}_{B B , {n}_{μ}}^{( μ )} = [ \begin{matrix}{f}_{BB , {n}_{μ} , 1}^{( μ )} , & {f}_{BB , {n}_{μ} , 2}^{( μ )} , & … , & {f}_{BB , {n}_{μ} K}^{( μ )}\end{matrix} ] ∈ {ℂ}^{{N}_{R F} \times K} . \qquad Equation 7$$

In Equation 7,

$${f}_{BB , {n}_{μ} , k}^{( μ )}$$

may indicate a baseband beamformer for the n₈₂^{th}SC of user k of numerology μ, [symbol] may indicate a complex field, N_{RF} may indicate the number of RF chains of the base station, and K may indicate a total number of users.

In Equation 22,

$${M}_{{μ}^{′}}^{( μ , {β}_{1} )}$$

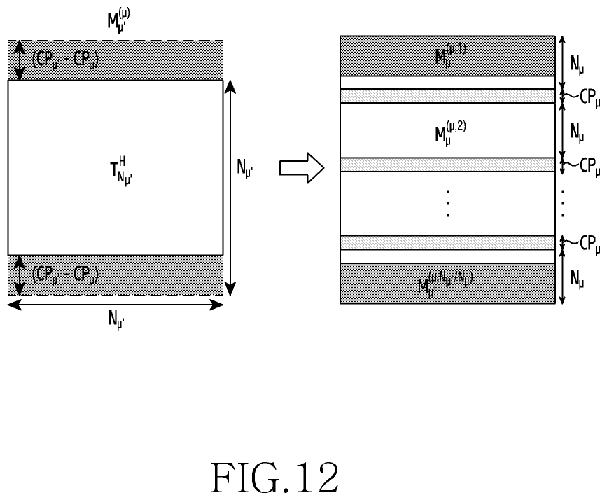

may be described together with FIG. 12.

FIG. 12 illustrates interference between users using different numerologies in a wireless communication system according to an embodiment of the disclosure.

Referring to FIG. 12, reconstructed matrix

$${M}_{{μ}^{′}}^{( μ )}$$

may be expressed by further adding a matrix of a size of (CP_{μ′}-CP_{μ})×N_{μ′} above and below

$${T}_{{N}_{μ}^{′}}^{H} ,$$

and

$${M}_{{μ}^{′}}^{( μ , {β}_{1} )}$$

may be expressed based on

$${M}_{{μ}^{′}}^{( μ )} .$$

The size of

$${M}_{{μ}^{′}}^{( μ )}$$

may be variously expressed according to N_{μ′}, CP_{μ}, and CP_{μ′}, and a partial matrix of

$${M}_{{μ}^{′}}^{( μ )}$$

may be defined as

$${M}_{{μ}^{′}}^{( μ , {β}_{1} )} \cdot {M}_{{μ}^{′}}^{( μ , {β}_{1} )}$$

may be a matrix including N_{μ} combinations of specific positions of

$${M}_{{μ}^{′}}^{( μ )} .$$

Returning to the description with reference to FIG. 11, according to an embodiment of the disclosure, when the SCS of the numerology that acts as interference is wider than the SCS of the numerology used by user k (i.e., μ′>μ), inter-NI received from the n′^{th} OFDM symbol of numerology μ′ by the n₈₂^{th} SCS data of the n^{th} OFDM symbol of user k using numerology μ may be expressed as Equation 24 below.

$${{μ}^{′} , {n}^{′}}_{( k , μ , n )}^{} [ {n}_{μ} ] = {Ψ}_{{μ}^{′} , {β}_{2}}^{( μ )} ( {n}_{μ} , : ) {\sum }_{{n}_{{μ}^{′}} = 1}^{{N}_{{μ}^{′}}} diag ( {T}_{{N}_{μ}} {b}_{{μ}^{′} , {n}_{{μ}^{′}}}^{( μ )} ) {\underbrace{{H}_{k}^{( μ )} {F}_{RF}}}_{= {\hat{H}}_{k}^{( μ )}} {{F}_{BB , {n}_{{μ}^{′}}}^{( {μ}^{′} )} ( {ζ}_{{n}_{{μ}^{′}}}^{( {μ}^{′} , {n}^{′} )} )}^{\frac{1}{2}} {s}_{{n}_{{μ}^{′}}}^{( {μ}^{′} , {n}^{′} )} \qquad Equation 24$$

$${Ψ}_{{μ}^{′} , {β}_{2}}^{( μ )} ( {n}_{μ} , : )$$

may indicate the n_{μ}th row vector of

$${Ψ}_{{μ}^{′} , {β}_{2}}^{( μ )} ,$$

N_{μ′} may indicate the total number of SCs of numerology μ′, diag

$$( {T}_{{N}_{μ}} {b}_{{μ}^{′} , {n}_{{μ}^{′}}}^{( μ )} )$$

may indicate a diagonal matrix having vector

$${T}_{{N}_{μ}} {b}_{{μ}^{′} , {n}_{{μ}^{′}}}^{( μ )}$$

as diagonal components, T_{N}_{_{μ}} may indicate an N_{μ}-point DFT unitary matrix, N, may indicate the total number of SCs of numerology μ,

$${b}_{{μ}^{′} , {n}_{{μ}^{′}}}^{( μ )}$$

may indicate the n_{μ′}th column vector of

$${B}_{{μ}^{′}}^{( μ )} ,$$

β₂ may indicate the relative position of the n′^{th} OFDM symbol of numerology μ′ from the perspective of the nth OFDM symbol of numerology μ in the time domain,

$${h}_{k}^{( {μ}^{′} , {n}_{{μ}^{′}} )}$$

may indicate the spatial domain channel when the channel between user k and the base station is expressed from the perspective of the n_{μ′}th SC, A^{T} may indicate the transpose of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${ζ}_{{n}_{{μ}^{′}}}^{( {μ}^{′} , {n}^{′} )}$$

may indicate a diagonal matrix as a power normalization factor applied to the n_{μ′}th SC in the n′^{th} OFDM symbol of numerology μ′,

$${s}_{{n}_{{μ}^{′}}}^{( {μ}^{′} , {n}^{′} )}$$

may indicate a data stream vector of the n_{μ′}th SC in the n′^{th} OFDM symbol of numerology μ′, and a[m] may indicate the mth component of vector a.

In Equation 24,

$${( {h}_{k}^{( μ )} )}^{T}$$

F_{RF} may indicate

$${( {\hat{h}}_{k}^{( μ )} )}^{T} .$$

In Equation 24, β₂ may be expressed as in Equation 25 below.

$${β}_{2} {=}^{Δ} mod ( n , \frac{{N}_{μ}}{{N}_{{μ}^{′}}} ) + \frac{{N}_{μ}}{{N}_{{μ}^{′}}} δ ( mod ( n , \frac{{N}_{μ}}{{N}_{{μ}^{′}}} ) ) \qquad Equation 25$$

In Equation 25, N_{μ} may indicate the total number of SCs in numerology μ, and N_{μ′} may indicate the total number of SCs in numerology μ′.

In Equation 24,

$${Ψ}_{{μ}^{′} , {β}_{2}}^{( μ )}$$

may be expressed as in Equation 26 below.

$${Ψ}_{{μ}^{′} , {β}_{2}}^{( μ )} {=}^{Δ} \{ \begin{matrix}[ {0}_{{N}_{μ} \times {CP}_{μ}} , {T}_{{N}_{μ}} ] [ \begin{matrix}{T}_{{N}_{μ}}^{H} \\ {0}_{{CP}_{μ} \times {N}_{μ}}\end{matrix} ] , & for {β}_{2} = 1 \\ {T}_{{N}_{μ}} {Φ}_{{μ}^{′} , {β}_{2}}^{( μ )} {T}_{{N}_{μ}}^{H} , & for 1 < {β}_{2} \leq \frac{{N}_{μ}}{{N}_{{μ}^{′}}}\end{matrix} \qquad Equation 26$$

In Equation 26, N_{μ} may indicate the total number of SCs of numerology μ, CP_{μ} may indicate the CP length of numerology μ, T_{N}_{_{μ}} may indicate an N_{μ}-point DFT unitary matrix, β₂ may indicate a relative position of the n′^{th} OFDM symbol of numerology μ′ from the perspective of the n^{th} OFDM symbol of numerology μ in the time domain, and N_{μ′} may indicate the total number of SCs of numerology μ′.

In Equation 26,

$${Φ}_{{μ}^{′} , {β}_{2}}^{( μ )}$$

may be expressed as in Equation 27 below.

$$\begin{matrix}Equation 27 & \\ {Φ}_{{μ}^{′} , {β}_{2}}^{( μ )} = [ \begin{matrix}{0}_{{ϕ}_{2 , 1} \times \frac{{N}_{μ}}{2}} & {0}_{{ϕ}_{2 , 1} \times \frac{{N}_{μ}}{2}} \\ {I}_{{ϕ}_{2 , 2}} & {0}_{{ϕ}_{2 , 2} \times ( {N}_{μ} - {ϕ}_{2 , 2} )} \\ {0}_{{ϕ}_{2 , 3} \times \frac{{N}_{μ}}{2}} & {0}_{{ϕ}_{2 , 3} \times \frac{{N}_{μ}}{2}}\end{matrix} ] . & ( 17 )\end{matrix}$$

In Equation 27, N_{μ} may indicate the total number of SCs for numerology μ, and I may indicate a unit matrix.

In Equation 27, φ_{2,1}, φ_{2,2}, and φ_{2,3} may be expressed as in Equation 28 below.

$$\{ \begin{matrix}{ϕ}_{2 , 1} = ( {β}_{2} - 1 ) ( {N}_{{μ}^{′}} + {CP}_{{μ}^{′}} ) - {CP}_{{μ}^{′}} \\ {ϕ}_{2 , 2} = \{ \begin{matrix}{N}_{{μ}^{′}} + {CP}_{{μ}^{′}} + {CP}_{μ} , & for 2 \leq {β}_{2} < \frac{{N}_{μ}}{{N}_{{μ}^{′}}} \\ {N}_{{μ}^{′}} + {CP}_{{μ}^{′}} , & for {β}_{2} = \frac{{N}_{μ}}{{N}_{{μ}^{′}}}\end{matrix} \\ {ϕ}_{2 , 3} = \{ \begin{matrix}( \frac{{N}_{μ}}{{N}_{{μ}^{′}}} - {β}_{2} ) ( {N}_{{μ}^{′}} + {CP}_{{μ}^{′}} ) - {CP}_{μ} , & for 2 \leq {β}_{2} < \frac{{N}_{μ}}{{N}_{{μ}^{′}}} \\ ( \frac{{N}_{μ}}{{N}_{{μ}^{′}}} - {β}_{2} ) ( {N}_{{μ}^{′}} + {CP}_{{μ}^{′}} ) , & for {β}_{2} = \frac{{N}_{μ}}{{N}_{{μ}^{′}}}\end{matrix}\end{matrix} , \qquad Equation 28$$

In Equation 28, β₂ may indicate a relative position of the n′^{th} OFDM symbol of numerology μ′ from the perspective of the n^{th} OFDM symbol of numerology μ in the time domain, N_{μ} may indicate the total number of SCs of numerology μ, N_{μ′} may indicate the total number of SCs of numerology μ′, and CP_{μ′} may indicate the CP length of numerology μ′.

In Equation 24,

$${b}_{{μ}^{′} , {n}_{{μ}^{′}}}^{( μ )}$$

may indicate the n_{μ′}^{th} column vector of

$${B}_{{μ}^{′}}^{( μ )} , and {B}_{{μ}^{′}}^{( μ )}$$

may be expressed as in Equation 29 below.

$${B}_{{μ}^{′}}^{( μ )} {=}^{Δ} [ \begin{matrix}[ {0}_{{CP}_{{μ}^{′}} \times ( {N}_{{μ}^{′}} - {CP}_{{μ}^{′}} )} , {I}_{{CP}_{{μ}^{′}}} ] {T}_{{N}_{{μ}^{′}}}^{H} \\ {T}_{{N}_{{μ}^{′}}}^{H} \\ {0}_{( {N}_{μ} - {N}_{{μ}^{′}} - {CP}_{{μ}^{′}} ) \times {N}_{{μ}^{′}}}\end{matrix} ] \qquad Equation 29$$

In Equation 29, N_{μ} may indicate the total number of SCs of numerology μ, N_{μ′} may indicate the total number of SCs of numerology μ′, CP_{μ′} may indicate the CP length of the numerology, I may indicate a unit matrix, and

$${T}_{{N}_{{μ}^{′}}}^{H}$$

may indicate an N_{μ′}-point IDFT unitary matrix.

In Equation 24,

$${F}_{BB , {n}_{μ}}^{( μ )}$$

may be expressed as in Equation 7 described above.

$${F}_{BB , {n}_{μ}}^{( μ )} = [ {f}_{BB , {n}_{μ} , 1}^{( μ )} , {f}_{BB , {n}_{μ} , 2}^{( μ )} , … , {f}_{BB , {n}_{μ} , K}^{( μ )} ] ∈ {ℂ}^{{N}_{RF} \times K} . \qquad Equation 7$$

In Equation 7,

$${f}_{BB , {n}_{μ} , k}^{( μ )}$$

may indicate a baseband beamformer for the n_{μ}th SC of user k with numerology μ, [symbol] may indicate a complex field, N_{RF} may indicate the number of RF chains of the base station, and K may indicate a total number of users.

The AWGN vector zₖ which has passed through the DFT in the receiver of a user using numerology μ may be expressed as in Equation 30 below.

$${z}_{k} ∼ CN ( {0}_{{N}_{μ} \times 1} , {N}_{0} {I}_{{N}_{μ}} ) . \qquad Equation 30$$

In Equation 30, [symbol] (x,y) may indicate a complex normal distribution having a mean of x and a variance of y, N₀ may indicate a spectral density of white noise, I may represent a unit matrix, and a˜b may indicate that random variable a follows probability distribution b.

The received signal

$${y}_{{n}_{μ}}^{( μ , n )} [ k ] ∈ ℂ$$

for the n_{μ}^{th} SC of the n^{th} OFDM symbol of user k using numerology μ may be expressed as in Equation 31 below.

$$Equation 31$$

$${y}_{{n}_{μ}}^{( μ , n )} [ k ] = {\underbrace{{d}^{( k , μ , n )} [ {n}_{μ} ]}}_{desired signal} + {\sum }_{{k}^{′} ∈ {𝒦}_{μ} , {k}^{′}} {\underbrace{{\overline{\overline{ι n ι}}}_{{k}^{′}}^{( k , μ , n )} [ {n}_{μ} ]}}_{intra - NI} + {\sum }_{{μ}^{′} \neq μ} {\sum }_{{n}^{′} = ⌊ \frac{( n - 1 ) N μ}{{N}_{{μ}^{′}}} ⌋ + 1}^{⌈ \frac{nN μ}{{N}_{{μ}^{′}}} ⌉} {\underbrace{{{μ}^{′} {n}^{′}}_{( k , μ , n )}^{} [ {n}_{μ} ]}}_{inter - NI} + {z}_{k} [ {n}_{μ} ]$$

In Equation 31, d^{(k,μ,n)} [n_{μ}] may indicate a desired signal,

$${\overline{\overline{ι n ι}}}_{{k}^{′}}^{( k , μ , n )} [ {n}_{μ} ]$$

may indicate inter-NI,

$${{μ}^{′} {n}^{′}}_{( k , μ , n )}^{} [ {n}_{μ} ]$$

may indicate inter-NI, and zₖ[n_{μ}] may indicate a noise vector, that is, AWGN, in user k using numerology μ.

In addition,

$${SINR}_{{n}_{μ} , k}^{( μ , n )}$$

corresponding to the SINR of the received signal

$${y}_{{n}_{μ}}^{( μ , n )} [ k ]$$

may be expressed as in Equation 32 below.

$$Equation 32$$

$${SINR}_{{n}_{μ} , k}^{( μ , n )} = \frac{𝔼 [ {\vert {d}^{( k , μ , n )} [ {n}_{μ} ] \vert}^{2} ]}{{\sum }_{{k}^{′} ∈ {𝒦}_{μ} , {k}^{′} \neq k} 𝔼 [ \vert {{\overline{\overline{ι n ι}}}_{{k}^{′}}^{( k , μ , n )} [ {n}_{μ} ] \vert}^{2} ] + {\sum }_{{μ}^{′} \neq μ} {\sum }_{{n}^{′} = ⌊ \frac{( n - 1 ) N μ}{{N}_{{μ}^{′}}} ⌋ + 1}^{⌈ \frac{nN μ}{{N}_{{μ}^{′}}} ⌉} 𝔼 [ \vert {{{\_}^{}}_{{μ}^{′} {n}^{′}}^{( k , μ , n )} [ {n}_{μ} ] \vert}^{2} ] + {N}_{0}}$$

In Equation 32, d^{(k,μ,n)}[n_{μ}] may indicate a desired signal,

$${\overline{\overline{ι n ι}}}_{{k}^{′}}^{( k , μ , n )} [ {n}_{μ} ]$$

may indicate intra-NI,

$${{μ}^{′} {n}^{′}}_{( k , μ , n )}^{} [ {n}_{μ} ]$$

may indicate inter-NI, zₖ[n_{μ}] may indicate a noise vector in user k using numerology μ, [symbol] [·] may indicate an expectation operator, |a| may indicate the absolute value of scalar a, N_{μ} may indicate the total number of SCs of numerology μ, N_{μ′} may indicate the total number of SCs of numerology μ′, k may indicate a user index, [symbol] may indicate a set of users using numerology μ, and N₀ may indicate the spectral density of white noise.

The transmission rate obtainable from the n_{μ}^{th} SC of the n^{th} OFDM symbol of user k using the numerology μ from

$${SINR}_{{n}_{μ} , k}^{( μ , n )}$$

may be expressed as in Equation 33 below.

$${R}_{{n}_{μ} , k}^{( μ , n )} = \frac{1}{1 + ρ} ( 1 + {SINR}_{{n}_{μ} , k}^{( μ , n )} ) {=}^{Δ} {ρ}^{′} {log}_{2} ( 1 + {SINR}_{{n}_{μ} , k}^{( μ , n )} ) . \qquad Equation 33$$

In Equation 33,

$${SINR}_{{n}_{μ} , k}^{( μ , n )}$$

may indicate the SINR for the received signal

$${y}_{{n}_{μ}}^{( μ , n )} [ k ] ,$$

and ρ may indicate a CP ratio.

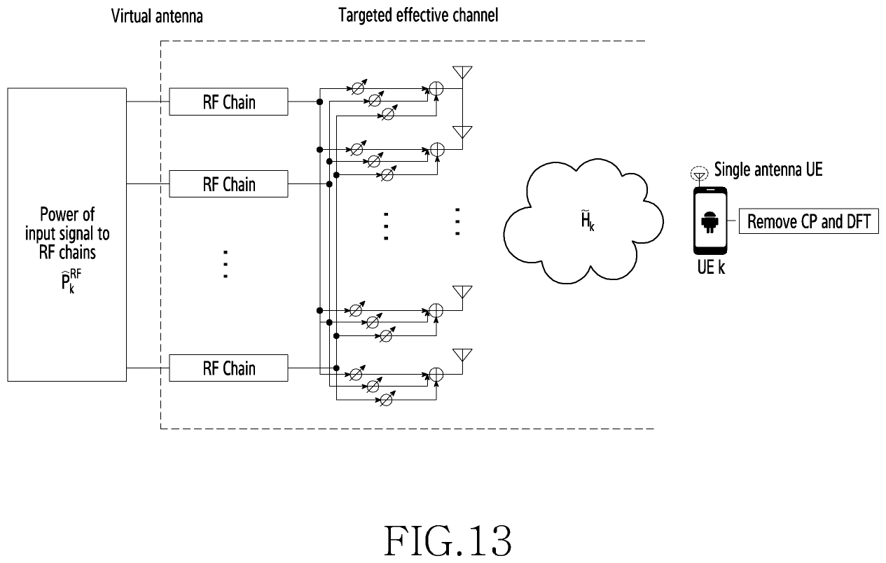

FIG. 13 illustrates a hybrid beamforming design in a wireless communication system according to an embodiment of the disclosure.

Referring to FIG. 13, an RF beamformer F_{RF} may be obtained through

$${\hat{p}}_{k}^{RF}$$

input to the RF chain, and may be combined with a baseband beamformer

$${f}_{BB , {n}_{μ} , k}^{( μ )}$$

to remove effective interferences. In addition, a power allocation matrix

$${ζ}_{{n}_{μ} , k}^{( μ , n )}$$

may be obtained as F_{RF} and

$${f}_{BB , {n}_{μ} , k}^{( μ )} ,$$

and a desired signal d^{(k,μ,n)} [n_{μ}], intra-NI

$${\overline{\overline{ι n ι}}}_{{k}^{′}}^{( k , μ , n )} [ {n}_{μ} ] ,$$

and inter-NI

$${{μ}^{′} , {n}^{′}}_{( k , μ , n )}^{} [ {n}_{μ} ]$$

may be obtained based on F_{RF},

$${f}_{BB , {n}_{μ} , k}^{( μ )} , and {ζ}_{{n}_{μ} , k}^{( μ , n )} ,$$

and a data rate may be obtained based thereon.

According to an embodiment of the disclosure, the transmission rate may be obtained through d^{(k,μ,n)}[n_{μ}], intra-NI

$${\overline{\overline{ι n ι}}}_{{k}^{′}}^{( k , μ , n )} [ {n}_{μ} ] ,$$

and inter-NI

$${{μ}^{′} , {n}^{′}}_{( k , μ , n )}^{} [ {n}_{μ} ] , {\hat{p}}_{k}^{RF}$$

may be obtained based on F_{RF} and

$${f}_{BB , {n}_{μ} , k}^{( μ )} ,$$

and the obtained

$${\hat{p}}_{k}^{RF}$$

may be input to the RF chain again to obtain the next F_{RF}. Thereafter, the next transmission rate may be obtained based on the next F_{RF}, and then if the next transmission rate is greater than the previous transmission rate, this may be repeated again and input to the RF chain.

According to an embodiment of the disclosure, after obtaining a transmission rate through d^{(k,μ,n)}[n_{μ}], intra-NI

$${\overline{\overline{ι n ι}}}_{{k}^{′}}^{( k , μ , n )} [ {n}_{μ} ] ,$$

and inter-NI

$${{μ}^{′} , {n}^{′}}_{( k , μ , n )}^{} [ {n}_{μ} ] ,$$

\hat{p}ₖ^{RF} may be obtained based on F_{RF} and

$${f}_{BB , {n}_{μ} , k}^{( μ )} ,$$

and the obtained

$${\hat{p}}_{k}^{RF}$$

may be input again to the RF chain to obtain the next F_{RF}. Thereafter, the next transmission rate may be obtained based on the next F_{RF}, and then if the next transmission rate is equal to or smaller than the previous transmission rate, the signal may be transmitted without repeating this anymore.

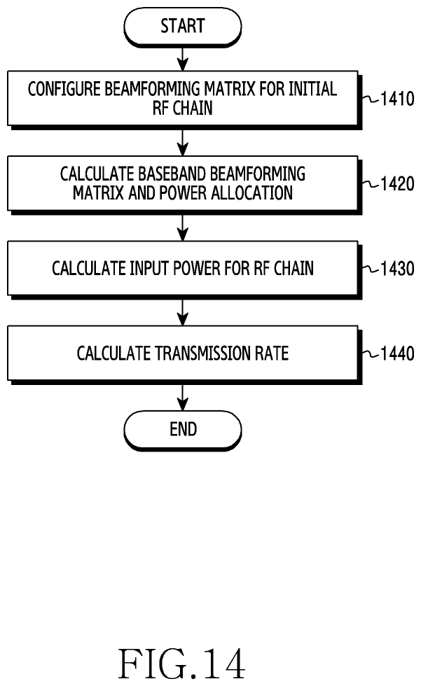

FIG. 14 is a flowchart illustrating obtaining an initial transmission rate for hybrid beamforming in a wireless communication system according to an embodiment of the disclosure.

According to an embodiment of the disclosure, the following operations (e.g., operations 1410 to 1440) may be performed by a controller (e.g., the controller 640 of FIG. 6) of a base station (the base station 110 of FIG. 1 or the base station 600 of FIG. 6).

Referring to FIG. 14, in operation 1410, the base station may configure an initial beamforming matrix F_{RF} for the RF chain. According to an embodiment of the disclosure, an initial beamforming matrix F_{RF} for the RF chain is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure. According to an embodiment of the disclosure, the initial beamforming matrix F_{RF} for the RF chain may be expressed as in Equation 4 above.

In operation 1420, a baseband beamforming matrix

$${f}_{BB , {n}_{μ} , k}^{( μ )}$$

and a power allocation matrix

$${ζ}_{{n}_{μ} , k}^{( μ , n )}$$

may be calculated. According to an embodiment of the disclosure, the baseband beamforming matrix

$${f}_{BB , {n}_{μ} , k}^{( μ )}$$

may indicate a baseband beamforming vector designed to transmit data

$${s}_{{n}_{μ}}^{( μ , n )} [ k ] .$$

According to an embodiment of the disclosure, the power allocation matrix

$${ζ}_{{n}_{μ} , k}^{( μ , n )}$$

may indicate a diagonal matrix as a power normalization factor applied to the n_{μ}^{th} SC in the n^{th} OFDM symbol of numerology μ.

According to an embodiment of the disclosure, the baseband beamforming matrix

$${f}_{BB , {n}_{μ} , k}^{( μ )}$$

and the power allocation matrix

$${ζ}_{{n}_{μ} , k}^{( μ , n )}$$

may be calculated based on the initial beamforming matrix F_{RF} for the RF chain. Specifically, the baseband beamforming matrix

$${f}_{BB , {n}_{μ} , k}^{( μ )}$$

may be calculated based on the initial beamforming matrix F_{RF} for the RF chain, and the power allocation matrix

$${ζ}_{{n}_{μ} , k}^{( μ , n )}$$

may be calculated based on the baseband beamforming matrix

$${f}_{BB , {n}_{μ} , k}^{( μ )}$$

and the initial beamforming matrix F_{RF} for the RF chain. The power allocation matrix

$${ζ}_{{n}_{μ} , k}^{( μ , n )}$$

may be expressed as in Equation 3 above.

The baseband beamforming matrix

$${f}_{BB , {n}_{μ} , k}^{( μ )}$$

may be described through the following description. The baseband beamforming matrix

$${f}_{BB , {n}_{μ} , k}^{( μ )}$$

may be designed to remove inter-NI. According to an embodiment of the disclosure, in order to remove an inter-NI in the baseband, the following conditions may be required.

In a case of μ′>μ, if

$${F}_{BB , {n}_{μ}}^{( μ )}$$

satisfies the condition of Equation 34 below through Equation 22 above, all the inter-NI may be removed.

$${( {\hat{h}}_{{k}^{′}}^{( μ , {n}_{μ} )} )}^{T} {F}_{BB , {n}_{μ}}^{( μ )} = {0}_{1 \times K} , ∀ {n}_{μ} \qquad Equation 34$$

In Equation 34,

$${\hat{h}}_{{k}^{′}}^{( μ , {n}_{μ} )}$$

may indicate a wireless channel corresponding to the d^{th} time delay tap of a channel between user k and the base station from the perspective of in the n_{μ}^{th} SC, A^{T} may indicate a transpose of matrix A, and K may indicate the total number of users.

In Equation 34,

$${\hat{h}}_{{k}^{′}}^{( μ , {n}_{μ} )}$$

may indicate

$${\hat{h}}_{{k}^{′}}^{( μ , {n}_{μ} )} = {h}_{{k}^{′}}^{( μ , {n}_{μ} )} {F}_{RF} , {h}_{{k}^{′}}^{( μ , {n}_{μ} )}$$

may indicate a spatial domain channel when the channel between user k and the base station is expressed from the perspective of the n_{μ}^{th} SC, and F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure.

In the case of μ′<μ, if

$${F}_{BB , {n}_{μ}}^{( μ )}$$

satisfies the condition of Equation 35 below through Equation 24 above, all the inter-NI may be removed.

$${\hat{H}}_{{k}^{′}}^{( {μ}^{′} )} {F}_{BB , {n}_{μ}}^{( μ )} = {0}_{{N}_{{μ}^{′}} \times K} , ∀ {n}_{μ} \qquad Equation 35$$

In Equation 35, N_{μ} may indicate the total number of SCs in the μ′^{th} numerology, and K may indicate the total number of users.

In Equation 35,

$${\hat{H}}_{{k}^{′}}^{( {μ}^{′} )}$$

may indicate

$${H}_{{k}^{′}}^{( {μ}^{′} )} {F}_{RF} , and {H}_{{k}^{′}}^{( {μ}^{′} )}$$

may indicate a frequency-spatial channel matrix when the channel between user k′ and the base station is expressed by N_{μ′} SCs, and F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure.

In Equation 35,

$${\hat{H}}_{{k}^{′}}^{( {μ}^{′} )}$$

may satisfy

$${\hat{H}}_{{k}^{′}}^{( {μ}^{′} )} = {H}_{{k}^{′}}^{( {μ}^{′} )} {F}_{RF} = \sqrt{{N}_{{μ}^{′}}} {T}_{{N}_{{μ}^{′}}} [ \begin{matrix}{\tilde{H}}_{{k}^{′}} \\ 0\end{matrix} ] {F}_{RF} , {N}_{{μ}^{′}}$$

may indicate the total number of SCs of numerology μ′, T_{N}_{_{μ′}} may indicate an N_{μ′}-point DFT unitary matrix, and \tilde{H}_{k′} may indicate a channel between user k and the base station, expressed in the time-spatial domain (\tilde{H}_{k′} is expressed in Equation 15).

According to Equation 15, the rank of \tilde{H}_{k′} may be less than or equal to min{CP_{μ′}+1, N_{CL,k′}}, CP_{μ′} may indicate the CP length of numerology μ′, and N_{CL,k′} may indicate the number of scatterer clusters in the channel to user k′. Therefore, when the number of RF chains of the base station is smaller than the number of antennas, but a sufficiently large number of RF chains exist, matrix

$${\hat{H}}_{{k}^{′}}^{( {μ}^{′} )}$$

may be a rank-dependent matrix in a massive MIMO system.

Therefore to remove inter-NI in condition μ′<μ, it is necessary to find a basis of the

$${\hat{H}}_{{k}^{′}}^{( {μ}^{′} )}$$

spatial domain and design a baseband beamforming orthogonal to the basis. To this end, an effective rank number of eigenvectors having a large eigenvalue among the eigenvectors of a positive semidefinite (PSD) matrix

$${( {\hat{H}}_{{k}^{′}}^{( {μ}^{′} )} )}^{H} {\hat{H}}_{{k}^{′}}^{( {μ}^{′} )}$$

may be considered as an interference channel. Mathematically, when the eigenvalue decomposition of matrix

$${( {\hat{H}}_{{k}^{′}}^{( {μ}^{′} )} )}^{H} {\hat{H}}_{{k}^{′}}^{( {μ}^{′} )}$$

is as expressed in Equation 36 below, a matrix including the first effective-rank column vectors of

$${Q}_{{k}^{′}}^{( {μ}^{′} )}$$

may be considered as an interference channel.

$${( {\hat{H}}_{{k}^{′}}^{( {μ}^{′} )} )}^{H} {\hat{H}}_{{k}^{′}}^{( {μ}^{′} )} = {{Q}_{{k}^{′}}^{( {μ}^{′} )} ( {\sum }_{{k}^{′}}^{( {μ}^{′} )} )}^{2} {( {Q}_{{k}^{′}}^{( {μ}^{′} )} )}^{H} \qquad Equation 36$$

In Equation 36,

$${\sum }_{{k}^{′}}^{( {μ}^{′} )}$$

may be a diagonal matrix having eigenvalues as diagonal components in descending order,

$${\hat{H}}_{{k}^{′}}^{( {μ}^{′} )}$$

may indicate

$${H}_{{k}^{′}}^{( {μ}^{′} )} {F}_{RF} , {H}_{{k}^{′}}^{( {μ}^{′} )}$$

may denote a frequency-spatial channel matrix when a channel between user k′ and the base station is represented by N_{μ} SCs, and A^{T} may indicate a transpose of matrix A.

The i^{th} diagonal component of

$${( {\sum }_{{k}^{′}}^{( {μ}^{′} )} )}^{2}$$

in Equation 36 may be referred to as

$${σ}_{{k}^{′} , {μ}^{′}}^{( i )} , and the {σ}_{{k}^{′} , {μ}^{′}}^{( i )}$$

value is normalized, and the normalized eigenvalue

$${κ}_{{k}^{′} , {μ}^{′}}^{( i )}$$

may be expressed as in Equation 37 below.

$${κ}_{{k}^{′} , {μ}^{′}}^{( i )} = \frac{{σ}_{{k}^{′} , {μ}^{′}}^{( i )}}{{\sum }_{j} {σ}_{{k}^{′} , {μ}^{′}}^{( i )}} \qquad Equation 37$$

In Equation 37,

$${σ}_{{k}^{′} , {μ}^{′}}^{( i )}$$

may indicate the i^{th} diagonal component of

$${( {\sum }_{{k}^{′}}^{( {μ}^{′} )} )}^{2} , and {\sum }_{{k}^{′}}^{( {μ}^{′} )}$$

may indicate a diagonal matrix having eigenvalues in descending order as diagonal components.

As Equation 37, erank

$$( {\hat{H}}_{{k}^{′}}^{( {μ}^{′} )} )$$

corresponding to the effective rank of

$${( {\hat{H}}_{{k}^{′}}^{( {μ}^{′} )} )}^{H} {\hat{H}}_{{k}^{′}}^{( {μ}^{′} )}$$

may be expressed as in Equation 38 below.

$$erank ( {\hat{H}}_{{k}^{′}}^{( {μ}^{′} )} ) {=}^{Δ} ⌈ exp {\sum }_{i} - {κ}_{{k}^{′} , {μ}^{′}}^{( i )} log ( {κ}_{{k}^{′} , {μ}^{′}}^{( i )} ) ) ⌉ \qquad Equation 38$$

In Equation 38,

$${κ}_{{k}^{′} , {μ}^{′}}^{( i )}$$

may indicate a normalized eigenvalue of a value of

$${σ}_{{k}^{′} , {μ}^{′}}^{( i )} , {σ}_{{k}^{′} , {μ}^{′}}^{( i )}$$

may indicate the i^{th} diagonal component of

$${( {\sum }_{{k}^{′}}^{( {μ}^{′} )} )}^{2} , {\sum }_{{k}^{′}}^{( {μ}^{′} )}$$

may indicate a diagonal matrix having eigenvalues in descending order as diagonal components, and ┌·┐ may indicate a ceiling function.

Therefore, in a case of μ′<μ, the effective interference channel considered to remove all inter-NI to user k′ for numerology μ′ of μ≠μ may be expressed as

$${[ {Q}_{{k}^{′}}^{( {μ}^{′} )} ( : , 1 : erank ( {\hat{H}}_{{k}^{′}}^{( {μ}^{′} )} ) ) ]}^{H} ∈ {ℂ}^{erank ( {\hat{H}}_{{k}^{′}}^{( {μ}^{′} )} ) \times {M}_{t}} . erank ( {\hat{H}}_{{k}^{′}}^{( {μ}^{′} )} )$$

may indicate the effective rank of

$${( {\hat{H}}_{{k}^{′}}^{( {μ}^{′} )} )}^{H} {\hat{H}}_{{k}^{′}}^{( {μ}^{′} )} ,$$

A^{T} may indicate a transpose of matrix A, [symbol] may indicate a complex field, Mₜ may indicate the total number of antennas of the base station, and A(:, n) may indicate the nth column vector of matrix A.

In addition, in a case of μ′<μ, the effective interference channel, which is considered to remove all inter-NI to user k′ for numerology μ′ of μ≠μ′, may be expressed as

$${[ {Q}_{{k}^{′}}^{( {μ}^{′} )} ( : , 1 : rank ( {\hat{H}}_{{k}^{′}}^{( {μ}^{′} )} ) ) ]}^{H} \cdot rank ( {\hat{H}}_{{k}^{′}}^{( {μ}^{′} )} )$$

may indicate a rank of

$${( {\hat{H}}_{{k}^{′}}^{( {μ}^{′} )} )}^{H} {\hat{H}}_{{k}^{′}}^{( {μ}^{′} )} ,$$

and A(:, n) may indicate the nth column vector of matrix A.

According to an embodiment of the disclosure, if the baseband beamforming matrix

$${F}_{BB , {n}_{μ}}^{( μ )}$$

exists in a right null space of matrix

$$[ \begin{matrix}⋮ \\ {( {\hat{h}}_{{k}^{′}}^{( μ , {n}_{μ} )} )}^{T} , ∀ {k}^{′} ∈ {𝒦}_{{μ}^{′} > μ} \\ ⋮\end{matrix} ]$$

that is obtained by stacking channel vectors

$${( {\hat{h}}_{{k}^{′}}^{( μ , {n}_{μ} )} )}^{T}$$

of users k′ of numerology μ′ (where, μ′>μ), all inter-NI for users of numerology μ′ of users of numerology μ can be removed by the baseband beamformer.

According to an embodiment of the disclosure, if the baseband beamforming matrix

$${F}_{BB , {n}_{μ}}^{( μ )}$$

exists the right null space of matrix

$$[ \begin{matrix}⋮ \\ {[ {Q}_{{k}^{′}}^{( {μ}^{′} )} ( : , 1 : erank ( {\hat{H}}_{{k}^{′}}^{( {μ}^{′} )} ) ) ]}^{H} , ∀ {k}^{′} ∈ {𝒦}_{{μ}^{′} < μ} \\ ⋮\end{matrix} ]$$

obtained by stacking the effective interference channels

$${[ {Q}_{{k}^{′}}^{( {μ}^{′} )} ( : , 1 : erank ( {\hat{H}}_{{k}^{′}}^{( {μ}^{′} )} ) ) ]}^{H}$$

of users k′ for numerology μ′(where, μ′<μ), most of the inter-NI for users of numerology μ′ of users of numerology μ can be removed by the baseband beamformer.

According to an embodiment of the disclosure, by combining the case where the above baseband beamforming matrix

$${F}_{BB , {n}_{μ}}^{( μ )}$$

corresponds to μ′>μ and the case where the above baseband beamforming matrix

$${F}_{BB , {n}_{μ}}^{( μ )}$$

corresponding to μ′<μ, for all μ′≠μ, if

$${F}_{BB , {n}_{μ}}^{( μ )}$$

exists in the right null space of matrix H̆^{(μ,n}^{_{μ}}⁾ which is expressed as in Equation 39 below, most of the inter-NI towards numerology μ′≠μ can be removed.

$${{H}^{⌣}}^{( μ , {n}_{μ} )} {=}^{Δ} [ \begin{matrix}⋮ \\ {{H}^{⌣}}_{{μ}^{′}}^{( μ , {n}_{μ} )} , ∀ {μ}^{′} \neq μ \\ ⋮\end{matrix} ] \qquad Equation 39$$

In Equation 39,

$${{H}^{⌣}}_{{μ}^{′}}^{( μ , {n}_{μ} )}$$

may be expressed as in Equation 40 below.

$${{H}^{⌣}}_{{μ}^{′}}^{( μ , {n}_{μ} )} {=}^{Δ} \{ \begin{matrix}[ \begin{matrix}⋮ \\ {( \frac{{\hat{h}}_{{k}^{′}}^{( μ , {n}_{μ} )}}{{‖ {\hat{h}}_{{k}^{′}}^{( μ , {n}_{μ} )} ‖}_{2}} )}^{T} , ∀ {k}^{′} ∈ {𝒦}_{{μ}^{′}} \\ ⋮\end{matrix} ] , & if {μ}^{′} > μ \\ [ \begin{matrix}⋮ \\ {[ {Q}_{{k}^{′}}^{( {μ}^{′} )} ( : , 1 : erank ( {\hat{H}}_{{k}^{′}}^{( {μ}^{′} )} ) ) ]}^{H} , ∀ {k}^{′} ∈ {𝒦}_{{μ}^{′} < μ} \\ ⋮\end{matrix} ] , & otherwise\end{matrix} , \qquad Equation 40$$

In Equation 40,

$${\hat{h}}_{{k}^{′}}^{( μ , {n}_{μ} )}$$

may indicate

$${\hat{h}}_{{k}^{′}}^{( μ , {n}_{μ} )} = {h}_{{k}^{′}}^{( μ , {n}_{μ} )} {F}_{RF} , {h}_{{k}^{′}}^{( μ , {n}_{μ} )}$$

may indicate the spatial domain channel when the channel between user k and the base station is expressed from the perspective of the n^{th} SC, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure, and ∥a∥₂ may indicate a Euclidean norm of vector a.

In Equation 40,

$$erank ( {\hat{H}}_{{k}^{′}}^{( {μ}^{′} )} )$$

may indicate the effective rank of

$${( {\hat{H}}_{{k}^{′}}^{( {μ}^{′} )} )}^{H} {\hat{H}}_{{k}^{′}}^{( {μ}^{′} )} ,$$

A^{T} may indicate a transpose of matrix A, [symbol] may indicate a complex field, Mₜ may indicate the total number of antennas of the base station, and A(:, n) may indicate the n^{th} column vector of matrix A.

According to an embodiment of the disclosure, the normalized channel matrix H̅^{(μ,n}^{_{μ}}⁾∈ [symbol] of users of the μ^{th} numerology interpreted from the perspective of the n_{μ}^{th} subcarrier may be expressed as in Equation 41 below, and if

$${f}_{BB , {n}_{μ} , k}^{( μ )} ∈ {ℂ}^{{M}_{t} \times 1} satisfies {\check{H}}_{{μ}^{′}}^{( μ , {n}_{μ} )} {f}_{BB , {n}_{μ} , k}^{( μ )} = 0 and {\overline{H}}^{( μ , {n}_{μ} )} {f}_{BB , {n}_{μ} , k}^{( μ )} = [ \begin{matrix}{0}_{( i - 1 ) \times 1} \\ 1 \\ {0}_{( \vert {𝒦}_{μ} \vert - 1 ) \times 1}\end{matrix} ]$$

satisfied when the i^{th} user index of [symbol] is k,

$${f}_{BB , {n}_{μ} , k}^{( μ )}$$

may be an effective zero-forcing (ZF) baseband beamformer in a hybrid beamforming structure supporting SS multi-numerology.

$${\overline{H}}^{( μ , {n}_{μ} )} {=}^{Δ} {[ \begin{matrix}\frac{{\hat{h}}_{min \{ {𝒦}_{μ} \}}^{( μ , {n}_{μ} )}}{{‖ {\hat{h}}_{min \{ {𝒦}_{μ} \}}^{( μ , {n}_{μ} )} ‖}_{2}} , & \frac{{\hat{h}}_{min \{ {𝒦}_{μ} \} + 1}^{( μ , {n}_{μ} )}}{{‖ {\hat{h}}_{min \{ {𝒦}_{μ} \} + 1}^{( μ , {n}_{μ} )} ‖}_{2}} , & … , & \frac{{\hat{h}}_{max \{ {𝒦}_{μ} \}}^{( μ , {n}_{μ} )}}{{‖ {\hat{h}}_{max \{ {𝒦}_{μ} \}}^{( μ , {n}_{μ} )} ‖}_{2}}\end{matrix} ]}^{T} ∈ {ℂ}^{\vert {𝒦}_{μ} \vert \times {M}_{t}} \qquad Equation 41$$

In Equation 41,

$${\hat{h}}_{{k}^{′}}^{( μ , {n}_{μ} )}$$

may indicate

$${\hat{h}}_{{k}^{′}}^{( μ , {n}_{μ} )} = {h}_{{k}^{′}}^{( μ , {n}_{μ} )} {F}_{RF} , {h}_{{k}^{′}}^{( μ , {n}_{μ} )}$$

may indicate a spatial domain channel when the channel between user k and the base station is expressed from the perspective of the n^{th} SC, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure, ∥a∥₂ may indicate a Euclidean norm of vector a, [symbol] may indicate a set of users using numerology μ, [symbol] may indicate a complex field, | [symbol] | may indicate the size of the set of users using numerology μ, and Mₜ may indicate the total number of antennas of the base station.

The effective zero-forcing (ZF) baseband beamformer may be expressed as in Equation 42 below.

$${f}_{BB , {n}_{μ} , k}^{( μ )} = {\frac{1}{{‖ {\hat{h}}_{k}^{( μ , {n}_{μ} )} ‖}_{2}} [ \begin{matrix}{\overline{H}}^{( μ , {n}_{μ} )} \\ {\check{H}}^{( μ , {n}_{μ} )}\end{matrix} ]}^{H} {( {[ \begin{matrix}{\overline{H}}^{( μ , {n}_{μ} )} \\ {\check{H}}^{( μ , {n}_{μ} )}\end{matrix} ] [ \begin{matrix}{\overline{H}}^{( μ , {n}_{μ} )} \\ {\check{H}}^{( μ , {n}_{μ} )}\end{matrix} ]}^{H} )}^{- 1} [ \begin{matrix}{0}_{( i - 1 ) \times 1} \\ 1 \\ {0}_{( {t}_{μ} - 1 ) \times 1}\end{matrix} ] \qquad Equation 42$$

In Equation 42,

$${\hat{h}}_{{k}^{′}}^{( μ , {n}_{μ} )}$$

may indicate

$${\hat{h}}_{{k}^{′}}^{( μ , {n}_{μ} )} = {h}_{{k}^{′}}^{( μ , {n}_{μ} )} {F}_{RF} , {h}_{{k}^{′}}^{( μ , {n}_{μ} )}$$

may indicate a spatial domain channel when the channel between user k and the base station is expressed from the perspective of the n_{μ}^{th} SC, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure, and ∥a∥₂ may indicate a Euclidean norm of vector a.

The H̅^{(μ,n}^{_{μ}}⁾ in Equation 42 may be expressed through Equation 41 above, and the H̆^{(μ,n}^{_{nμ}}⁾ may be expressed through Equation 40 above.

In operation 1430, input power

$${\hat{p}}_{k}^{RF}$$

for the RF chain may be calculated. Although operation 1440 is indicated to be performed after operation 1430 in FIG. 14, the disclosure is not limited to the indication of drawing.

The input power

$${\hat{p}}_{k}^{RF}$$

for the RF chain may be calculated in order to calculate the following transmission rate. Specifically, the next F_{RF} may be calculated through the input power

$${\hat{p}}_{k}^{RF}$$

for the RF chain, and the next transmission rate may be obtained based on the next F_{RF}.

The Input power

$${\hat{p}}_{k}^{RF}$$

for the RF chain may be calculated based on F_{RF} and

$${f}_{BB , {n}_{μ} , k}^{( μ )} .$$

Specifically, the input power

$${\hat{p}}_{k}^{RF}$$

for the RF chain may be expressed as in Equation 43 below.

$${\hat{p}}_{k , {n}_{μ}}^{RF} = {\sum }_{n = 1}^{{N}_{1} / {N}_{μ}} {\hat{p}}_{k , n , {n}_{μ}}^{RF} = {\sum }_{n = 1}^{{N}_{1} / {N}_{μ}} \frac{{‖ {f}_{BB , {n}_{μ} , k}^{( μ )} ‖}_{2}^{2}}{{‖ {F}_{RF} {f}_{BB , {n}_{μ} , k}^{( μ )} ‖}_{2}^{2}} {p}_{{n}_{μ} , k}^{( μ , n )} \qquad Equation 43$$

In Equation 43, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${f}_{BB , {n}_{μ} , k}^{( μ )}$$

may indicate a baseband beamforming vector designed to transmit data

$${s}_{{n}_{μ}}^{( μ , n )} [ k ] , {s}_{{n}_{μ}}^{( μ , n )}$$

may indicate a data stream vector of the n_{μ}^{th} SC in the n^{th} OFDM symbol of numerology μ,

$${p}_{{n}_{μ} , k}^{( μ , n )}$$

may indicate signal power allocated to the n_{μ}^{th} SC in the n^{th} OFDM symbol of user k for numerology μ, and ∥a∥₂ may indicate a Euclidean norm of vector a.

In operation 1440, a transmission rate Rₜₒₜ may be calculated. According to an embodiment of the disclosure, after obtaining the initial transmission rate, the next transmission rate may be calculated, and if the next transmission rate is smaller than or equal to the previous transmission rate, a signal may be transmitted without further repeating the same.

According to an embodiment of the disclosure, after obtaining the initial transmission rate, the next transmission rate may be calculated, and if the next transmission rate is larger than the previous transmission rate, the transmission rate may be further obtained.

According to an embodiment of the disclosure, the transmission rate Rₜₒₜ may be calculated based on the

$$SIN {R}_{{n}_{μ} , k}^{( μ , n )}$$

obtained in Equation 32 below. Specifically, the transmission rate Rₜₒₜ may be expressed by Equation 44 below.

$${R}_{tot} = {\sum }_{μ = 1}^{M} {\sum }_{k ∈ {𝒦}_{μ}} {R}_{k ∈ {𝒦}_{μ}} \qquad Equation 44$$

In Equation 44, [symbol] may be expressed as in Equation 45 below.

$${R}_{k ∈ {𝒦}_{μ}} = \frac{1}{{N}_{1} ( 1 + ρ )} [ {\sum }_{n = 1}^{\frac{{N}_{1}}{{N}_{μ}}} \{ {\sum }_{{n}_{μ} = 1}^{{N}_{μ}} {log}_{2} ( 1 + SIN {R}_{{n}_{μ} , k}^{( μ , n )} ) \} ] \qquad Equation 45$$

In Equation 45, N_{μ} may indicate the total number of SCs of numerology μ, ρ may indicate the CP ratio, and

$$SIN {R}_{{n}_{μ} , k}^{( μ , n )}$$

may be expressed as Equation 32.

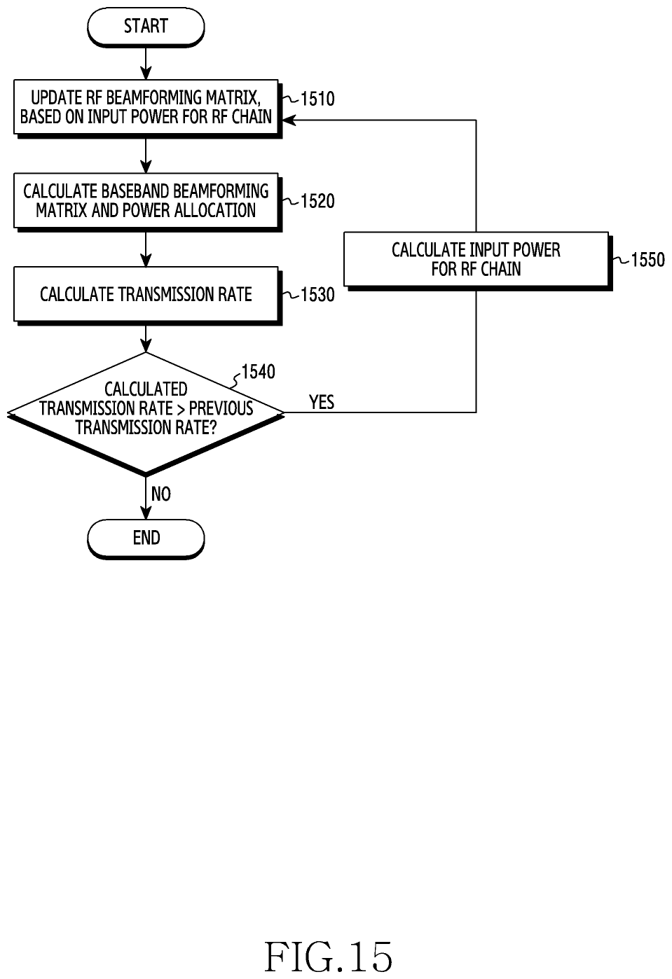

FIG. 15 is a flowchart illustrating transmitting a signal, based on a transmission rate in a hybrid beamforming structure in a wireless communication system according to an embodiment of the disclosure.

According to an embodiment of the disclosure, the following operations (e.g., operations 1510 to 1550) may be performed by a controller (e.g., the controller 640 of FIG. 6) of a base station (the base station 110 of FIG. 1 or the base station 600 of FIG. 6).

Referring to FIG. 15, in operation 1510, the base station may obtain the next beamforming matrix F_{RF} for the RF chain, based on the input power

$${\hat{p}}_{k}^{RF}$$

for the RF chain.

According to an embodiment of the disclosure, the process of obtaining the next beamforming matrix F_{RF} may differ according to whether the structure is a fully connected hybrid beamforming structure or a partially connected hybrid beamforming structure.

According to an embodiment of the disclosure, the process of obtaining the next beamforming matrix F_{RF} may differ according to whether the structure is a fully connected hybrid beamforming structure or a partially connected hybrid beamforming structure.

According to an embodiment of the disclosure, the beamforming matrix F_{RF} may be obtained by Equation 49 below in the fully connected hybrid beamforming structure, and the beamforming matrix F_{RF} may be obtained by Equation 53 below in the partially connected hybrid beamforming structure.

According to an embodiment of the disclosure, the strength of the signal due to the n_{μ}^{th} subcarrier data of the n^{th} OFDM symbol of user k, among the input signals entering the RF chains, may be denoted by

$${\hat{p}}_{k , n , {n}_{μ}}^{RF} ,$$

and the transmission rate at the RF chain stage, which is obtainable by user k in the n^{th} OFDM symbol may satisfy Equation 46 below.

$${\hat{R}}_{k , n}^{RF} \leq {ρ}^{′} {log}_{2} ( 1 + \frac{1}{{N}_{μ}} \frac{1}{{N}_{0}} Tr [ {( {F}_{RF} )}^{H} {( {H}_{k}^{( μ )} )}^{H} {\hat{p}}_{k , n}^{RF} {H}_{k}^{( μ )} {F}_{RF} ] ) \qquad Equation 46$$

In Equation 46, ρ′ may indicate

$$\frac{1}{1 + ρ} ,$$

ρ may indicate a CP ratio,

$${\hat{p}}_{k}^{RF}$$

may indicate input power for an RF chain, N_{μ} may indicate a total number of SCs of the μ^{th} numerology, N₀ may indicate a spectrum density of white noise, Tr[A] may indicate a sum of diagonal components of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${H}_{k}^{( μ )}$$

may indicate a frequency-space channel matrix when the channel between user k and the base station is expressed by N_{μ} SCs, and A^{H} may indicate a conjugate transpose of matrix A.

In Equation 46,

$${\hat{P}}_{k , n}^{RF}$$

is a diagonal matrix, and the n_{μ}^{th} diagonal component of

$${\hat{P}}_{k , n}^{RF} is {\hat{p}}_{k , n , {n}_{μ}}^{RF} {N}_{μ} {T}_{s} ,$$

that is,

$${\hat{P}}_{k , n}^{RF} ( {n}_{μ} , {n}_{μ} ) = {\hat{p}}_{k , n , {n}_{μ}}^{RF} {N}_{μ} {T}_{s} .$$

Through Equation 46, the transmission rate at the RF chain stage, which is obtainable by user k of the μt^{h} numerology for T_{LCM} may satisfy Equation 47 below.

$${\hat{R}}_{k}^{RF} = \frac{{N}_{μ}}{{N}_{1}} {\sum }_{n = 1}^{\frac{{N}_{1}}{{N}_{μ}}} {\hat{R}}_{k , n}^{RF} \leq {ρ}^{′} {log}_{2} ( 1 + \frac{1}{{N}_{1}} \frac{1}{{N}_{0}} Tr [ {( {F}_{RF} )}^{H} {( {H}_{k}^{( μ )} )}^{H} ( {\underbrace{{\sum }_{n = 1}^{\frac{{N}_{1}}{{N}_{μ}}} {\hat{P}}_{k , n}^{RF}}}_{{=}^{Δ} {\hat{P}}_{k , n}^{RF}} ) {H}_{k}^{( μ )} {F}_{RF} ] ) \qquad Equation 47$$

In Equation 47, ρ′ may indicate

$$\frac{1}{1 + ρ} ,$$

ρ may indicate a CP ratio,

$${\hat{p}}_{k}^{RF}$$

may indicate the input power to the RF chain, N_{μ} may indicate the total number of SCs in the μ^{th} numerology, N₀ may indicate the spectral density of white noise, Tr[A] may indicate the sum of the diagonal components of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${H}_{k}^{( μ )}$$

may indicate a frequency-space channel matrix when the channel between user k and the base station is expressed by N_{μ} SCs, and A^{H} may indicate a conjugate transpose of matrix A.

If all users are considered as distributed reception antennas of a single virtual user and interference cancellation is perfectly performed at the receiver end, the upper bound obtained by extending Equation 47 is expressed as Equation 48 below.

$${\hat{R}}_{UB}^{RF} = K {ρ}^{′} {log}_{2} ( 1 + \frac{1}{K} \frac{1}{{N}_{1}} \frac{1}{{N}_{0}} Tr [ {( {F}_{RF} )}^{H} {\sum }_{μ = 1}^{M} {\sum }_{k ∈ {𝒦}_{μ}} [ ( {H}_{k}^{( μ )} ) {\hat{P}}_{k}^{RF} {H}_{k}^{( μ )} ] {F}_{RF} ] ) \qquad Equation 48$$

In Equation 48, ρ′ may indicate

$$\frac{1}{1 + ρ} ,$$

ρ may indicate a CP ratio,

$${\hat{p}}_{k}^{RF}$$

may indicate input power for an RF chain, N_{μ} may indicate a total number of SCs for the μ^{th} numerology, N₀ may indicate a spectral density of white noise, Tr[A] may indicate the sum of diagonal components of matrix A, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${H}_{k}^{( μ )}$$

may indicate a frequency-spatial channel matrix when a channel between user k and a base station is indicated by N_{μ} SCs, A^{H} may indicate a conjugate transpose of matrix A, M may indicate a total number of numerologies, K may indicate a total number of users, and [symbol] may indicate a set of users using the μ^{th} numerology.

An RF beamforming matrix design method according to an embodiment of the disclosure may designing that each element (in a partially connected structure, a phase shift value of a phase shifter corresponding to a part in which an antenna element and an RF chain are connected) has the same magnitude while maximizing Equation 48 below.

In order to maximize Equation 48, a value of F_{RF} that maximizes the value of

$$Tr [ {( {F}_{RF} )}^{H} {\sum }_{μ = 1}^{M} {\sum }_{k ∈ {𝒦}_{μ}} [ ( {H}_{k}^{( μ )} ) {\hat{P}}_{k}^{RF} {H}_{k}^{( μ )} ] {F}_{RF} ]$$

needs to be found. A method for designing an RF beamforming matrix, which is proposed to maximize Equation 44, is divided according to the case where the HBF structure is a fully connected HBF structure and the case where the HBF structure is a partially connected structure, and described. The designed RF beamforming matrix may be stored in the buffer.

In the fully connected hybrid beamforming structure according to an embodiment of the disclosure, RF beams may be sequentially formed in the form of first adjusting the values of the phase shifter connected to the first RF chain and then adjusting the values of the phase shifter connected to the second RF chain. In other words, the RF beamforming matrix design method may be a method of sequentially designing from f_{RF,1} to f_{RF,N}_{_{RF}} in F_{RF}=[f_{RF,1}, f_{RF,2}, . . . , f_{RF,N}_{_{RF}}].

In the fully connected hybrid beamforming structure according to an embodiment of the disclosure, the initial beamforming vector f⁽⁰⁾∈ [symbol] may be configured such that the magnitude of each element is

$$\frac{1}{\sqrt{{M}_{t}}}$$

and the phase is an arbitrary value between 0 and 2π. The beamforming vector f^{(p)} for the μ^{th} repetition process may be expressed as in Equation 49 below.

$${f}^{( p )} = \frac{1}{\sqrt{{M}_{t}}} {e}^{( 1 j ∠ ( {A}^{{( {n}_{RF} )}_{f} ( p - 1 )} ) )} \qquad Equation 49$$

In Equation 49, Mₜ may indicate the total number of base station antennas, <(a) may indicate a function for extracting phases of elements of vector a, and n_{RF} may indicate a base station RF chain index.

In Equation 49, A⁽ⁿ^{_{RF}}⁾ may be expressed as in Equation 50 below.

$${A}^{( {n}_{RF} )} {=}^{Δ} \{ \begin{matrix}( I - {{f}_{RF , {n}_{RF} - 1} ( {f}_{RF , {n}_{RF} - 1} )}^{H} ) {A}^{( {n}_{RF} - 1 )} ( I - {{f}_{RF , {n}_{RF} - 1} ( {f}_{RF , {n}_{RF} - 1} )}^{H} ) , & when {n}_{RF} > 1 \\ {\sum }_{μ = 1}^{M} {\sum }_{k ∈ {𝒦}_{μ}} [ {( {H}_{k}^{( μ )} )}^{H} {\hat{P}}_{k}^{RF} {H}_{k}^{( μ )} ] , & when {n}_{RF} = 1\end{matrix} \qquad Equation 50$$

In Equation 50, f_{RF,n}_{_{RF}}₋₁ may be expressed through the relationship between F_{RF} and F_{RF}=[f_{RF,1}, f_{RF,2}, . . . , f_{RF,N}_{_{RF}}], F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${H}_{k}^{( μ )}$$

may indicate a frequency-spatial channel matrix when the channel between user k and the base station is expressed by N_{μ} SCs, A^{H} may indicate a conjugate transpose of matrix A,

$${\hat{p}}_{k}^{RF}$$

may indicate the input power for the RF chains, [symbol] may indicate a set of users using the μ^{th} numerology, n_{RF} may indicate an index of the base station RF chain, and I may indicate a unit matrix.

In the fully connected hybrid beamforming structure according to an embodiment of the disclosure, if Equation 49 is repeated to satisfy f^{(p)}≈f^{(p-1)}, a value of f^{(p)} may be determined as f_{RF,n}_{_{RF}}. The expression for n_{RF}>1 in Equation 50 may be an expression to ensure that a newly designed RF beamforming vector does not exist in the same space as the previously designed RF beamforming vectors.

In the partially connected hybrid beamforming structure according to an embodiment of the disclosure, the partially connected means that the RF chains are connected to only some of the antenna elements, and one antenna element is also connected to only one RF chain, so that the RF beamforming vectors of the RF chains may be independently designed.

In the fully connected hybrid beamforming structure according to an embodiment of the disclosure an antenna index set connected to the n_{RF}^{th} RF chain may be defined as [symbol] . The (i,j)^{th} element of matrix Sₙ_{_{RF}}∈ [symbol] that represents the connection between the n_{RFth} RF chain and the antenna may be expressed as in Equation 51 below.

$${S}_{{n}_{RF}} ( i , j ) = \{ \begin{matrix}1 , & if i ∈ {𝒮}_{{n}_{RF}} and i is the j - th smallest number in {𝒮}_{{n}_{RF}} \\ 0 , & otherwise\end{matrix} \qquad Equation 51$$

In Equation 51, [symbol] may indicate an antenna index set connected to the n_{RF}^{th} RF chain.

For example, when the base station has two RF chains and four antenna elements, the first RF chain is connected to the first and third antenna elements through a phase shifter, and the second RF chain is connected to the remaining antenna elements, matrix Sₙ_{_{RF}} may be expressed as in Equation 52 below.

$${S}_{{n}_{RF}} = \{ \begin{matrix}[ \begin{matrix}1 & 0 \\ 0 & 0 \\ 0 & 1 \\ 0 & 0\end{matrix} ] , & if {n}_{RF} = 1 , \\ [ \begin{matrix}0 & 0 \\ 1 & 0 \\ 0 & 0 \\ 0 & 1\end{matrix} ] , & otherwise\end{matrix} \qquad Equation 52$$

In Equation 52, n_{RF} may indicate a base station RF chain index.

The initial beamforming vector f⁽⁰⁾∈ [symbol] may be configured such that each element has the magnitude of

$$\frac{1}{\sqrt{{M}_{t}}}$$

and the phase of an arbitrary value between 0 and 2π, and the following process may be repeated to determine the value of the phase shifter connected to the n_{RF}^{th} RF chain. A beamforming vector f^{(p)} for the p^{th} process may be expressed as in Equation 53 below.

$${f}^{( p )} = \frac{1}{\sqrt{{M}_{t}}} {e}^{( 1 j ∠ ( {\sum }_{μ = 1}^{M} {\sum }_{k ∈ {𝒦}_{μ}} [ {{S}_{{n}_{RF}}^{T} ( {H}_{k}^{( μ )} )}^{H} {\hat{P}}_{k}^{RF} {H}_{k}^{( μ )} {S}_{{n}_{RF}} ] {f}^{( p - 1 )} ) )} \qquad Equation 53$$

In Equation 53, Mₜ may indicate the total number of base station antennas, Sₙ_{_{RF}} may indicate a matrix expressing the connection between the n_{RF}^{th} RF chain and the antenna,

$${H}_{k}^{( μ )}$$

may indicate the frequency-spatial channel matrix when the channel between user k and the base station is expressed by N_{μ} SCs, A^{H} may indicate the conjugate transpose of matrix A,

$${\hat{p}}_{k}^{R F}$$

may indicate the input power for the RF chain, [symbol] may indicate the set of users using the μ^{th} numerology, and n_{RF} may indicate the base station RF chain index.

In the partially connected hybrid beamforming structure according to an embodiment of the disclosure, Equation 53 may be repeated until f^{(p)}≈f^{(p-1)} is satisfied. Thereafter, the i^{th} element of f^{(p)} may be determined as the phase shift value of the phase shifter between the RF chain and the antenna element having the ith smallest antenna index among the antenna elements connected to the n_{RF}^{th} RF chain. Therefore, the f_{RF,n}_{_{RF}} obtained from the beamforming vector f^{(p)} converged by repeatedly performing Equation 53 may be expressed as in Equation 54 below.

$${f}_{RF , {n}_{RF}} = {S}_{{n}_{RF}} {f}^{( p )} \qquad Equation 54$$

In Equation 54, Sₙ_{_{RF}} may indicate a matrix expressing a connection between the n_{RF}^{th} RF chain and the antenna, and f^{(p)} may indicate a beamforming vector for the p^{th} repetition process.

In operation 1520, a baseband beamforming matrix

$${f}_{BB , {n}_{μ} , k}^{( μ )}$$

and a power allocation matrix

$${ζ}_{{n}_{μ} , k}^{( μ , n )}$$

may be calculated. According to an embodiment of the disclosure, the baseband beamforming matrix

$${f}_{BB , {n}_{μ} , k}^{( μ )}$$

may indicate a baseband beamforming vector designed to transmit data

$${s}_{{n}_{μ}}^{( μ , n )} [ k ] .$$

According to an embodiment of the disclosure, the power allocation matrix

$${ζ}_{{n}_{μ} , k}^{( μ , n )}$$

may indicate a diagonal matrix as a power normalization factor applied to the n_{μ}^{th} SC in the n^{th} OFDM symbol of the μ^{th} numerology.

According to an embodiment of the disclosure, the baseband beamforming matrix

$${f}_{BB , {n}_{μ} , k}^{( μ )}$$

and the power allocation matrix

$${ζ}_{{n}_{μ} , k}^{( μ , n )}$$

may be calculated based on the beamforming matrix F_{RF} for the RF chain. Specifically, the baseband beamforming matrix

$${f}_{BB , {n}_{μ} , k}^{( μ )}$$

may be calculated based on the beamforming matrix F_{RF} for the RF chain, and the power allocation matrix

$${ζ}_{{n}_{μ} , k}^{( μ , n )}$$

may be calculated based on the baseband beamforming matrix

$${f}_{BB , {n}_{μ} , k}^{( μ )}$$

and the beamforming matrix F_{RF} for the RF chain.

According to an embodiment of the disclosure, the baseband beamforming matrix

$${f}_{BB , {n}_{μ} , k}^{( μ )}$$

may be expressed as in Equation 42 above, and the power allocation matrix

$${ζ}_{{n}_{μ} , k}^{( μ , n )}$$

may be expressed as in Equation 3 above.

In operation 1540, the transmission rate Rₜₒₜ may be calculated. According to an embodiment of the disclosure, when the next transmission rate is equal to or less than the previous transmission rate, the signal may be performed without further repeating.

In operation 1540, if the next transmission rate is greater than the previous transmission rate, the next beamforming matrix F_{RF} for the RF chain may be obtained based on the input power

$${\hat{p}}_{k}^{RF}$$

for the next RF chain, and the transmission rate may be further obtained based thereon. In other words, if the next transmission rate is greater than the previous transmission rate, the process may proceed to operation 1550.

According to an embodiment of the disclosure, the transmission rate Rₜₒₜ may be expressed as in Equation 44 above.

In operation 1550, the inpt power

$${\hat{p}}_{k}^{RF}$$

for the RF chain may be calculated. The input power

$${\hat{p}}_{k}^{RF}$$

for the RF chain may be calculated to calculate the next transmission rate. Specifically, the next F_{RF} may be calculated through the input power

$${\hat{p}}_{k}^{RF}$$

for the RF chain, and then the next transmission rate may be obtained based on the next F_{RF}.

The input power

$${\hat{p}}_{k}^{RF}$$

for the RF chain may be calculated based on F_{RF} and

$${f}_{BB , {n}_{μ} , k}^{( μ )} .$$

Specifically, the input power

$${\hat{p}}_{k}^{RF}$$

for the RF chain may be expressed as in Equation 43 above.

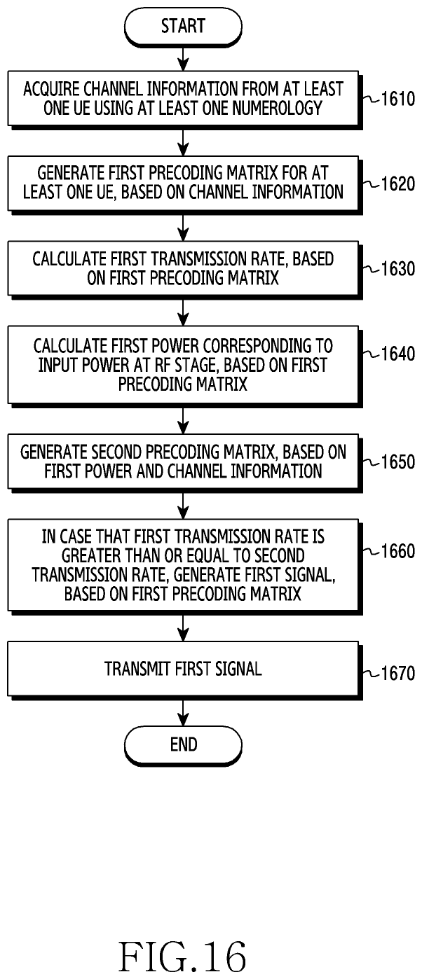

FIG. 16 is a flowchart illustrating transmitting a signal, based on hybrid beamforming in a wireless communication system according to an embodiment of the disclosure.

According to an embodiment of the disclosure, the following operations (e.g., operations 1610 to 1670) may be performed by a controller (e.g., the controller 640 of FIG. 6) of a base station (e.g., the base station 110 of FIG. 1 or the base station 600 of FIG. 6).

Referring to FIG. 16, in operation 1610, the base station may acquire channel information from at least one UE that uses at least one numerology. The channel information may be information on channels between a plurality of antennas and a plurality of reception antennas of one or more UEs, respectively. For example, the channel information for a first UE may include individual channel information for each of one or more antennas included in the first UE.

According to an embodiment of the disclosure, among the multiple antennas included in one or more UEs, a first group may use a first numerology and a second group may use a second numerology.

For example, a first SCS of the first numerology may be narrower than a second SCS of the second numerology. As another example, the first SCS of the first numerology may be wider than the second SCS of the second numerology.

Each of the multiple reception antennas may use one of the multiple numerologies, and among the multiple reception antennas, one or more reception antennas using the first numerology may be included in the first group, and one or more reception antennas using the second numerology may be included in the second group.

In operation 1620, the base station may generate a first precoding matrix for a first group that uses the first numerology, based on the acquired channel information. The first precoding matrix may be generated to reduce interference occurring in a signal received from a group using a numerology other than the first numerology.

According to an embodiment of the disclosure, the first precoding matrix may include an initial beamforming matrix F_{RF} for an RF chain, a baseband beamforming matrix

$${f}_{BB , {n}_{μ} , k}^{( μ )} ,$$

and a power allocation matrix

$${ζ}_{{n}_{μ} , k}^{( μ , n )} .$$

According to an embodiment of the disclosure, an initial beamforming matrix F_{RF} for the RF chain is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure. According to an embodiment of the disclosure, the initial beamforming matrix F_{RF} for the RF chain may be expressed as in Equation 4 above.

A baseband beamforming matrix

$${f}_{BB , {n}_{μ} , k}^{( μ )}$$

and a power allocation matrix

$${ζ}_{{n}_{μ} , k}^{( μ , n )}$$

may be calculated. According to an embodiment of the disclosure, the baseband beamforming matrix

$${f}_{BB , {n}_{μ} , k}^{( μ )}$$

may indicate a baseband beamforming vector designed to transmit data

$${s}_{{n}_{μ}}^{( μ , n )} [ k ] .$$

According to an embodiment of the disclosure, the power allocation matrix

$${ζ}_{{n}_{μ} , k}^{( μ , n )}$$

may indicate a diagonal matrix as a power normalization factor applied to the n_{μ}^{th} SC in the n^{th} OFDM symbol of the μ^{th} numerology.

According to an embodiment of the disclosure, the baseband beamforming matrix

$${f}_{BB , {n}_{μ} , k}^{( μ )}$$

and the power allocation matrix

$${ζ}_{{n}_{μ} , k}^{( μ , n )}$$

may be calculated based on the beamforming matrix F_{RF} for the RF chain. Specifically, the baseband beamforming matrix

$${f}_{BB , {n}_{μ} , k}^{( μ )}$$

may be calculated based on the beamforming matrix F_{RF} for the RF chain, and the power allocation matrix

$${ζ}_{{n}_{μ} , k}^{( μ , n )}$$

may be calculated based on the baseband beamforming matrix

$${f}_{BB , {n}_{μ} , k}^{( μ )}$$

and the beamforming matrix F_{RF} for the RF chain.

According to an embodiment of the disclosure, the baseband beamforming matrix

$${f}_{BB , {n}_{μ} , k}^{( μ )}$$

may be expressed as in Equation 42 above, and the power allocation matrix

$${ζ}_{{n}_{μ} , k}^{( μ , n )}$$

may be expressed as in Equation 3 above.

In operation 1630, a first transmission rate may be calculated based on the first precoding matrix. The transmission rate Rₜₒₜ may be expressed as in Equation 44 above.

In operation 1640, a first power corresponding to the input power of the RF stage may be calculated based on the first precoding matrix.

The first power corresponding to the input power of the RF stage may correspond to the process of calculating a first input power

$${\hat{p}}_{k}^{RF}$$

for the RF chain. The input power

$${\hat{p}}_{k}^{RF}$$

for the RF chain may be calculated to calculate the next transmission rate. Specifically, the next F_{RF} may be calculated through the input power

$${\hat{p}}_{k}^{RF}$$

for the RF chain, and then the next transmission rate may be obtained based on the next F_{RF}.

The input power

$${\hat{p}}_{k}^{RF}$$

for the RF chain may be calculated based on F_{RF}
and

$${f}_{BB , {n}_{μ} , k}^{( μ )} .$$

Specifically, the input power

$${\hat{p}}_{k}^{RF}$$

for the RF chain may be expressed as in Equation 43 above.

In operation 1650, a second precoding matrix may be generated based on the first power and the channel information.

The second precoding matrix may be generated to reduce interference caused by a signal received in a group using a numerology other than the first numerology.

According to an embodiment of the disclosure, the second precoding matrix may include a beamforming matrix F_{RF} for an RF chain, a baseband beamforming matrix

$${f}_{BB , {n}_{μ} , k}^{( μ )} ,$$

and a power allocation matrix

$${ζ}_{{n}_{μ} , k}^{( μ , n )} .$$

According to an embodiment of the disclosure, the base station may obtain the next beamforming matrix F_{RF} for the RF chain, based on the input power

$${\hat{p}}_{k}^{RF}$$

for the RF chain.

According to an embodiment of the disclosure, the process of obtaining the next beamforming matrix F_{RF} may differ according to whether the structure is a fully connected hybrid beamforming structure or a partially connected hybrid beamforming structure.

According to an embodiment of the disclosure, the process of obtaining the next beamforming matrix F_{RF} may differ according to whether the structure is a fully connected hybrid beamforming structure or a partially connected hybrid beamforming structure.

According to an embodiment of the disclosure, in the fully connected hybrid beamforming structure, the beamforming matrix F_{RF} may be obtained by Equation 49 above, and in the partially connected hybrid beamforming structure, the beamforming matrix F_{RF} may be obtained by Equation 53 above.

A baseband beamforming matrix

$${f}_{BB , {n}_{μ} , k}^{( μ )}$$

and a power allocation matrix

$${ζ}_{{n}_{μ} , k}^{( μ , n )}$$

may be calculated. According to an embodiment of the disclosure, a baseband beamforming matrix

$${f}_{BB , {n}_{μ} , k}^{( μ )}$$

may indicate a baseband beamforming vector designed to transmit data

$${s}_{{n}_{μ}}^{( μ , n )} [ k ] .$$

According to an embodiment of the disclosure, the power allocation matrix

$${ζ}_{{n}_{μ} , k}^{( μ , n )}$$

may indicate a diagonal matrix as a power normalization factor applied to the n_{μ}^{th} SC in the n^{th} OFDM symbol of the μ^{th} numerology.

According to an embodiment of the disclosure, the baseband beamforming matrix

$${f}_{BB , {n}_{μ} , k}^{( μ )}$$

and the power allocation matrix

$${ζ}_{{n}_{μ} , k}^{( μ , n )}$$

may be calculated based on the beamforming matrix F_{RF} for the RF chain. Specifically, the baseband beamforming matrix

$${f}_{BB , {n}_{μ} , k}^{( μ )}$$

may be calculated based on the beamforming matrix F_{RF} for the RF chain, and the power allocation matrix

$${ζ}_{{n}_{μ} , k}^{( μ , n )}$$

may be calculated based on the baseband beamforming matrix

$${f}_{BB , {n}_{μ} , k}^{( μ )}$$

and the beamforming matrix F_{RF} for the RF chain.

According to an embodiment of the disclosure, the baseband beamforming matrix

$${F}_{BB , {n}_{μ} , k}^{( μ )}$$

may be expressed as in Equation 42 above, and the power allocation matrix

$${ζ}_{{n}_{μ} , k}^{( μ , n )}$$

may be expressed as in Equation 3 above.

In operation 1660, in case that the first transmission rate is equal to or larger than the second transmission rate, a first signal may be generated based on the first precoding matrix.

According to an embodiment of the disclosure, a transmission rate Rₜₒₜ may be calculated. According to an embodiment of the disclosure, if the next transmission rate is less than or equal to the previous transmission rate, the repetition may no longer be performed, and the first signal generated based on the first precoding matrix may be transmitted.

Although not illustrated, in operation 1660, if the next transmission rate is greater than the previous transmission rate, the next beamforming matrix F_{RF} for the RF chain may be obtained based on the input power

$${\hat{p}}_{k}^{RF}$$

for the next RF chain, and the transmission rate may be further obtained based thereon.

In operation 1670, the first signal may be transmitted. The first signal may be a first signal generated based on the first precoding matrix.

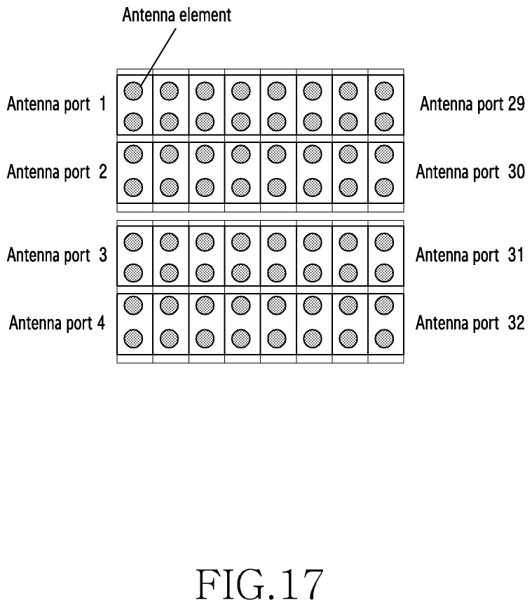

FIG. 17 illustrates antenna elements existing based on partially connected hybrid beamforming in a wireless communication system according to an embodiment of the disclosure.

Referring to FIG. 17, the transmission antenna array of the base station is a uniform planar array (UPA) array, and eight single-polarized antenna elements are arranged along each axis, and it can be identified that a total of 64 antenna elements exist. Referring to FIG. 17, it can be identified that the number of RF chains is 32, which is half of the number of base station antenna elements. In addition, referring to FIG. 17, a connection relationship between the RF chains and the antenna elements in the partially connected hybrid beamforming structure may be identified. Referring to FIG. 17, a box in which two antenna elements are grouped may indicate a set of antennas connected to each antenna port. In a fully connected hybrid beamforming structure, as many RF chains as the number of base station antenna elements (e.g., 64 in FIG. 17) may exist.

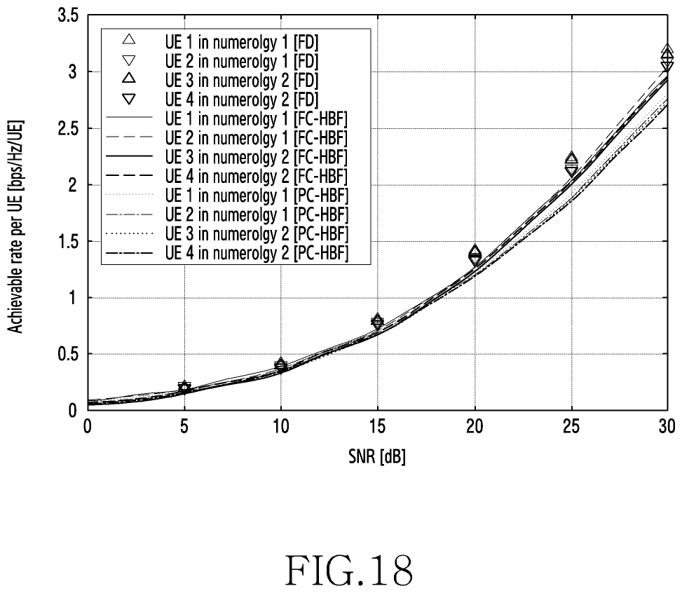

FIG. 18 illustrates a total transmission rate of each user in a clustered delay line-A (CDL-A) channel model according to an embodiment of the disclosure.

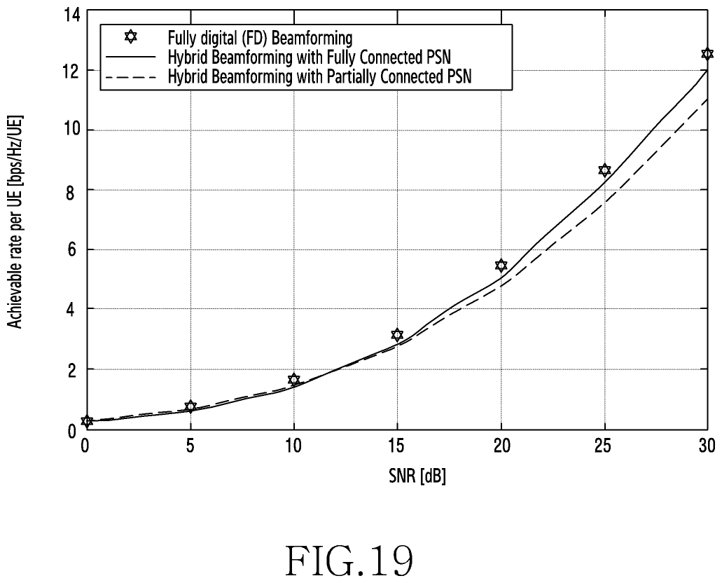

FIG. 19 illustrates a total transmission rate of the entire system in the CDL-A channel model according to an embodiment of the disclosure.

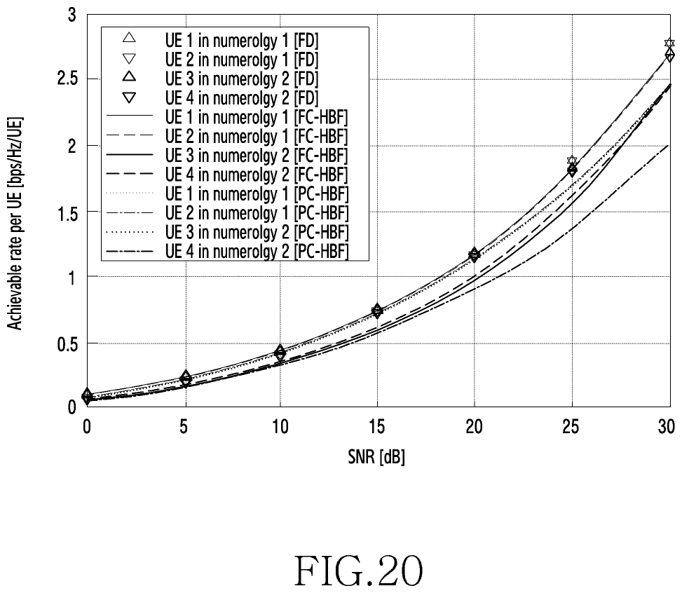

FIG. 20 illustrates a total transmission rate of a user in a clustered delay line-D (CDL-D) channel model according to an embodiment of the disclosure.

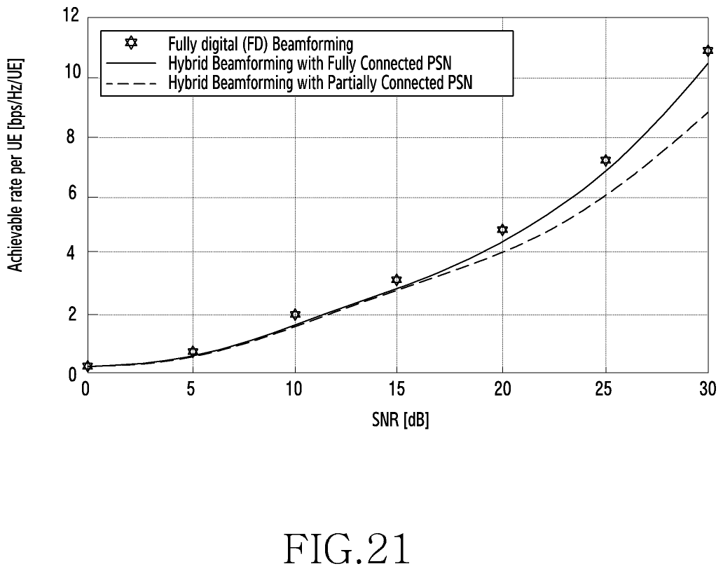

FIG. 21 illustrates a total transmission rate of the entire system in the CDL-D channel model in a wireless communication system according to an embodiment of the disclosure.

FIGS. 18 to 21 illustrate results of simulation based on the CDL-A and CDL-D models. In this case, the simulation has been performed under the following conditions. Here, the CDL-A channel model may be a channel model in a non-line of sight (NLOS), and the CDL-D channel model may be a channel model in the non-line of sight (NLOS) and a line of sight (LOS).

The number of numerologies is 2, and there are two users for each numerology.

The number of SCs of numerologies 1 and 2 are 128 and 64, respectively, and the CP ratio is 9/32, which is the same for the two numerologies.

The delay spread is set to 30 ns and 10 ns for the users using numerologies 1 and 2, respectively.

The distribution information of AoD, AoA, ZoA, and ZoD is as follows.
Mean angle: Unif(0, 360) degrees for AoD and AoA & Unif(0, 180) degrees for ZoA and ZoD
Angular spread: Unif(5, 25) degrees for AoD, Unif(30, 60) degrees for AoA, Unif(5, 15) degrees for ZoAUnif(1, 5), degrees for ZoD

In this case, Unif refers to a uniform distribution.

Hereinafter, the performance parameters in FIGS. 18 to 21 may be expressed by using Table 2 below.

TABLE 2

| ┌ Parameter | ┐ Value |
|---|---|
| └ Number of base | ┐ 64 |
| station antennas (Mₜ) | |
| ⊏ Total number of | ⊐ 2 |
| numerologies (M) | |
| └ Number of SCs for | ┐ N₁ = 128, N₂ = 64 |
| each numerology (N_{μ}) | |
| \| Number of users for | ⊐ \| [symbol] \| = 2, \| [symbol] \|= 2 |
| each numerology (\| [symbol] \|) | |
| └ CP ratio (ρ) | ┘ 9/32 |

Referring to FIGS. 18 to 21, it can be identified that the beamforming method according to an embodiment of the disclosure is applicable not only to a base station having a ULA antenna array, but also to a base station having a UPA antenna array. In addition, it can be identified that the beamforming method according to an embodiment of the disclosure may be used in the fully connected hybrid beamforming structure as well as in the partially connected hybrid beamforming structure. Furthermore, as the design freedom decreases, that is, FD BF→FC-HBF→PC HBF, the transmission rate through beamforming degrades, but it can be identified that a performance close to that of FD BF can be obtained with a small number of RF chains.

According to various embodiments of the disclosure, a method performed by a base station may be provided. The method may include acquiring channel information from one or more terminals by using one or more numerologies, generating, based on the channel information, a first precoding matrix for the one or more terminals, calculating, based on the first precoding matrix, a first transmission rate, calculating, based on the first precoding matrix, a first power corresponding to an input power of a radio frequency (RF) stage, generating, based on the first power and the channel information, a second precoding matrix, calculating, based on the second precoding matrix, a second transmission rate, in case that the first transmission rate is greater than or equal to the second transmission rate, generating, based on the first precoding matrix, a first signal corresponding to signals to be transmitted through multiple antennas of the base station, and transmitting the first signal through the multiple antennas.

According to an embodiment of the disclosure, the method may further include in case that the first transmission rate is smaller than the second transmission rate, calculating, based on the second precoding matrix, a second power corresponding to the input power of the RF stage, generating, based on the second power, a third precoding matrix, calculating, based on the third precoding matrix, a third transmission rate, in case that the second transmission rate is greater than or equal to the third transmission rate, generating, based on the second precoding matrix, a second signal corresponding to signals to be transmitted through the multiple antennas of the base station, and transmitting the second signal through the multiple antennas.

According to an embodiment of the disclosure, the channel information may be information on channels between the multiple antennas and multiple reception antennas of the one or more terminals.

According to an embodiment of the disclosure, each of the multiple reception antennas may use any one of the one or more numerologies.

According to an embodiment of the disclosure, the first precoding matrix may be based on a first RF beamformer and a first baseband beamformer.

According to an embodiment of the disclosure, the first RF beamformer may be determined based on f^{(p)} in Equation a expressed below.

$${f}^{( p )} = \frac{1}{\sqrt{{M}_{t}}} {e}^{( 1 j ∠ ( {A}^{( {n}_{RF} )} {f}^{( p - 1 )} ) )} \qquad Equation a$$

In Equation a, Mₜ may indicate a total number of antennas of a base station, function <(a) may indicate a function for extracting phases of elements of vector a, n_{RF} may indicate a base station RF chain index, and f^{(p)} may indicate a beamforming vector for a μ^{th} repetition process.

in Equation a above, A⁽ⁿ^{_{RF}}⁾ may be expressed as in Equation b below.

$${A}^{( {n}_{RF} )} {=}^{Δ} \{ \begin{matrix}( I - {{f}_{RF , {n}_{RF} - 1} ( {f}_{RF , {n}_{RF} - 1} )}^{H} ) {A}^{( {n}_{RF} - 1 )} ( I - {{f}_{RF , {n}_{RF} - 1} ( {f}_{RF , {n}_{RF} - 1} )}^{H} ) , & when {n}_{RF} > 1 \\ {\sum }_{μ = 1}^{M} {\sum }_{k ∈ {𝒦}_{μ}} [ {( {H}_{k}^{( μ )} )}^{H} {\hat{P}}_{k}^{RF} {H}_{k}^{( μ )} ] , & when {n}_{RF} = 1\end{matrix} . \qquad Equation b$$

In Equation b above, f_{RF,n}_{_{RF−1}} may be indicated through a relationship between F_{RF} and F_{RF}=[f_{RF,1}, f_{RF,2}, . . . , f_{RF,N}_{_{RF}}], F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${H}_{k}^{( μ )}$$

may indicate a frequency-spatial channel matrix in case that a channel between user k and the base station is indicated by N_{μ} SCs, A^{H} may indicate a conjugate transpose of matrix A,

$${\hat{p}}_{k}^{RF}$$

may indicate an input power to the RF chain, [symbol] may indicate a user set using a μ^{th} numerology, n_{RF} may indicate the base station RF chain index, and I may indicate a unit matrix.

According to an embodiment of the disclosure, the first RF beamformer may be determined based on f^{(p)} included in Equation c expressed below.

$${f}^{( p )} = \frac{1}{\sqrt{{M}_{t}}} {e}^{( 1 j ∠ ( {\sum }_{μ = 1}^{M} {\sum }_{k ∈ {𝒦}_{μ}} [ {{S}_{{n}_{RF}}^{T} ( {H}_{k}^{( μ )} )}^{H} {\hat{P}}_{k}^{RF} {H}_{k}^{( μ )} {S}_{{n}_{RF}} ] {f}^{( p - 1 )} ) )} \qquad Equation c$$

In Equation c, Mₜ may indicate a total number of antennas of a base station, Sₙ_{_{RF}} may indicate a matrix that expresses a connection between an n_{RF}^{th} RF chain and an antenna,

$${H}_{k}^{( μ )}$$

may indicate a frequency-spatial channel matrix in case that a channel between user k and the base station is indicated by N_{μ} SCs, A^{H} indicates a conjugate transpose of matrix A,

$${\hat{p}}_{k}^{RF}$$

may indicate an input power to the RF chain, [symbol] may indicate a user set using a μ^{th} numerology, and n_{RF} may indicate the base station RF chain index.

In Equation c, an (i,j)^{th} element of Sₙ_{_{RF}} may be expressed as in Equation d below.

$$( 27 )$$

$${S}_{{n}_{RF}} ( i , j ) = \{ \begin{matrix}1 , & if i ∈ {𝒮}_{{n}_{RF}} and i is the j - th smallest number in {𝒮}_{{n}_{RF}} \\ 0 , & otherwise\end{matrix} . \qquad Equation d$$

In Equation d above, [symbol] may indicate an antenna index set connected to an n_{RF}^{th} RF chain.

According to an embodiment of the disclosure, the first precoding matrix may be generated to reduce interference occurring in a signal received by a terminal group using one numerology among the one or more numerologies.

According to an embodiment of the disclosure, the first precoding matrix may be generated to reduce interference occurring in a signal received by a terminal group using a numerology other than the one of the one or more numerologies.

According to an embodiment of the disclosure, the first power may be expressed as in Equation e.

$${\hat{p}}_{k , {n}_{μ}}^{RF} = {\sum }_{n = 1}^{{N}_{1} / {N}_{μ}} {\hat{p}}_{k , n , {n}_{μ}}^{RF} = {\sum }_{n = 1}^{{N}_{1} / {N}_{μ}} \frac{{‖ {f}_{BB , {n}_{μ} , k}^{( μ )} ‖}_{2}^{2}}{{‖ {F}_{RF} {f}_{BB , {n}_{μ} , k}^{( μ )} ‖}_{2}^{2}} {p}_{{n}_{μ} , k}^{( μ , n )} \qquad Equation e$$

In Equation e, F_{RF} is an RF beamformer of a base station, and may indicate a matrix in which all components have the same magnitude in a fully connected hybrid beamforming structure, and only values corresponding to a part having an RF chain and an antenna connected therein have the same non-zero value in a partially connected beamforming structure,

$${f}_{BB , {n}_{μ} , k}^{( μ )}$$

may indicate a baseband beamforming vector designed to transmit data

$${s}_{{n}_{μ}}^{( μ , n )} [ k ] , {s}_{{n}_{μ}}^{( μ , n )}$$

may indicate a data stream vector of an n_{μ}^{th} SC within an n^{th} OFDM symbol of a μ^{th} numerology,

$${p}_{{n}_{μ} , k}^{( μ , n )}$$

may indicate a signal power allocated to the n_{μ}^{th} SC within the n^{th} OFDM symbol of the μ^{th} numerology for user k, and ∥a∥₂ may indicate a Euclidean norm of vector a.

According to various embodiments of the disclosure, a base station in a wireless communication system may be provided. The base station may include a communication unit, and a controller connected to the communication unit, wherein the controller is configured to acquire channel information from one or more terminals by using one or more numerologies, generate, based on the channel information, a first precoding matrix for the one or more terminals, calculate, based on the first precoding matrix, a first transmission rate, calculate, based on the first precoding matrix, a first power corresponding to an input power of a radio frequency (RF) stage, generate, based on the first power and the channel information, a second precoding matrix, calculate, based on the second precoding matrix, a second transmission rate, in case that the first transmission rate is greater than or equal to the second transmission rate, generate, based on the first precoding matrix, a first signal corresponding to signals to be transmitted through multiple antennas of the base station, and transmit the first signal through the multiple antennas.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
acquiring, by the base station, channel information from one or more terminals using one or more numerologies;
based on the channel information, generating, by the base station, a first precoding matrix for the one or more terminals;
based on the first precoding matrix, calculating, by the base station, a first transmission rate;
based on the first precoding matrix, calculating, by the base station, first power corresponding to input power of a radio frequency (RF) stage;
based on the first power and the channel information, generating, by the base station, a second precoding matrix;
based on the second precoding matrix, calculating, by the base station, a second transmission rate;
in case that the first transmission rate is greater than or equal to the second transmission rate, generating, by the base station based on the first precoding matrix, a first signal corresponding to signals to be transmitted through multiple antennas of the base station; and
transmitting, by the base station, the first signal through the multiple antennas.

2. The method of claim 1, further comprising:
in case that the first transmission rate is smaller than the second transmission rate, calculating, by the base station based on the second precoding matrix, second power corresponding to the input power of the RF stage;
based on the second power, generating, by the base station, a third precoding matrix;
based on the third precoding matrix, calculating, by the base station, a third transmission rate;
in case that the second transmission rate is greater than or equal to the third transmission rate, generating, by the base station based on the second precoding matrix, a second signal corresponding to signals to be transmitted through the multiple antennas of the base station; and
transmitting, by the base station, the second signal through the multiple antennas.

3. The method of claim 1,
wherein the channel information includes information on channels between the multiple antennas and multiple reception antennas of the one or more terminals, and
wherein each of the multiple reception antennas uses any one of the one or more numerologies.

4. The method of claim 1, wherein the first precoding matrix is based on a first RF beamformer and a first baseband beamformer.

5. The method of claim 4,
wherein the first RF beamformer is determined based on f^{(p)} included in Equation a expressed below:
$${f}^{( p )} = \frac{1}{\sqrt{{M}_{t}}} {e}^{( 1 j ∠ ( {A}^{{( {n}_{R F} )}_{{f}^{( p - 1 )}}} ) )} , \qquad Equation a$$
wherein, in Equation a, Mₜ indicates a total number of antennas of the base station, function <(a) indicates a function for extracting phases of elements of vector a, n_{RF} indicates a base station RF chain index, and f^{(p)} indicates a beamforming vector for a p^{th} repetition process,
wherein, in Equation a above, A⁽ⁿ^{_{RF}}⁾ is expressed as in Equation b below:
$${A}^{( {n}_{R F} )} {=}^{Δ} \{ \begin{matrix}\begin{matrix}( I - {{f}_{R F , {n}_{R F} - 1} ( {f}_{R F , {n}_{R F} - 1} )}^{H} ) {A}^{( {n}_{R F} - 1 )} \\ ( I - {{f}_{R F , {n}_{R F} - 1} ( {f}_{R F , {n}_{R F} - 1} )}^{H} )\end{matrix} , & when {n}_{R F} > 1 \\ {\sum }_{μ = 1}^{M} {\sum }_{k ∈ {𝒦}_{μ}} [ {( {H}_{k}^{( μ )} )}^{H} {\hat{P}}_{k}^{R F} {H}_{k}^{( μ )} ] , & when {n}_{R F} = 1\end{matrix} , and \qquad Equation b$$
wherein, in Equation b, f_{RF,n}_{_{RF−1}} is indicated through a relationship between F_{RF} and F_{RF}=[f_{RF,1}, f_{RF,2}, . . . , f_{RF,N}_{_{RF}}], F_{RF} is an RF beamformer of a base station, and indicates a matrix in which all components have the same magnitude in a fully connected hybrid beamforming structure, and only values corresponding to a part having an RF chain and an antenna connected therein have the same non-zero value in a partially connected beamforming structure,
$${H}_{k}^{( μ )}$$
indicates a frequency-spatial channel matrix in case that a channel between user k and the base station is indicated by N_{μ} subcarriers (SCs), A^{H} indicates a conjugate transpose of matrix A,
$${\hat{p}}_{k}^{R F}$$
indicates an input power to the RF chain, [symbol] indicates a user set using a μ^{th} numerology, n_{RF} indicates the base station RF chain index, and I indicates a unit matrix.

6. The method of claim 4,
wherein the first RF beamformer is determined based on f^{(p)} included in Equation c expressed below:
$${f}^{( p )} = \frac{1}{\sqrt{{M}_{t}}} {e}^{( 1 j ∠ ( {\sum }_{μ = 1}^{M} {\sum }_{k ∈ {𝒦}_{μ}} [ {{S}_{{N}_{RF}}^{T} ( {H}_{k}^{( μ )} )}^{H} {\hat{P}}_{k}^{RF} {H}_{k}^{( μ )} {S}_{{n}_{RF}} ] {f}^{( p - 1 )} ) )} , \qquad Equation c$$
wherein, in Equation c, Mₜ indicates a total number of antennas of a base station, Sₙ_{_{RF}} indicates a matrix that expresses a connection between an n_{RF}^{th} RF chain and an antenna,
$${H}_{k}^{( μ )}$$
indicates a frequency-spatial channel matrix in case that a channel between user k and the base station is indicated by N_{μ} subcarriers (SCs), A^{H} indicates a conjugate transpose of matrix A,
$${\hat{p}}_{k}^{R F}$$
indicates an input power to the RF chain, [symbol] indicates a user set using a μ^{th} numerology, and n_{RF} indicates the base station RE chain index,
wherein, in Equation c, an (i,j)^{th} element of Sₙ_{_{RF}} is expressed as in Equation d below:
$$\begin{matrix}( 27 ) & \\ {S}_{{n}_{R F}} ( i , j ) = \{ \begin{matrix}1 , & if i ∈ {𝒮}_{{n}_{RF}} and i is the j - th smallest number in {𝒮}_{{n}_{RF}} \\ 0 , & otherwise\end{matrix} , & Equation d\end{matrix}$$
and
wherein, in Equation d, [symbol] indicates an antenna index set connected to an n_{RF}^{th} RF chain.

7. The method of claim 1,
wherein the first precoding matrix is generated to reduce interference occurring in a signal received by a first terminal group using one numerology among the one or more numerologies, and
wherein the first precoding matrix is generated to reduce interference occurring in a signal received by a second terminal group using a numerology other than the one numerology among the one or more numerologies.

8. The method of claim 1,
wherein the first power is expressed as in Equation e below:
$${\hat{p}}_{k , {n}_{μ}}^{R F} = {\sum }_{n = 1}^{{N}_{1} / {N}_{μ}} {\hat{p}}_{k , n , {n}_{μ}}^{R F} = {\sum }_{n = 1}^{{N}_{1} / {N}_{μ}} \frac{{‖ {f}_{BB , {n}_{μ} , k}^{( μ )} ‖}_{2}^{2}}{{‖ {F}_{R F} {f}_{BB , {n}_{μ} , k}^{( μ )} ‖}_{2}^{2}} {p}_{{n}_{μ} , k}^{( μ , n )} , \qquad Equation e$$
wherein, in Equation e, F_{RF} is an RF beamformer of a base station, and indicates a matrix in which all components have the same magnitude in a fully connected hybrid beamforming structure, and only values corresponding to a part having an RF chain and an antenna connected therein have the same non-zero value in a partially connected beamforming structure,
$${f}_{BB , {n}_{μ} , k}^{( μ )}$$
indicates a baseband beamforming vector designed to transmit data
$${s}_{{n}_{μ}}^{( μ , n )} [ k ] , {s}_{{n}_{μ}}^{( μ , n )}$$
indicates a data stream vector of an n_{μ}^{th} subcarrier (SC) within an n^{th} orthogopal fguency division multiplexing (OFDM) symbol of a μ^{th} numerology,
$${p}_{{n}_{μ} , k}^{( μ , n )}$$
indicates a signal power allocated to the n_{μ}^{th} SC within the n^{th} OFDM symbol of the μ^{th} numerology for user k, and ∥a∥₂ indicates a Euclidean norm of vector a.

9. A base station in a wireless communication system, the base station comprising:
a transceiver;
memory, comprising one or more storage media, storing instructions; and
at least one processor communicatively coupled to the transceiver and the memory,
wherein the instructions, when executed by the at least one processor individually or collectively, cause the base station to:
acquire channel information from one or more terminals using one or more numerologies,
based on the channel information, generate a first precoding matrix for the one or more terminals,
based on the first precoding matrix, calculate a first transmission rate,
based on the first precoding matrix, calculate first power corresponding to input power of a radio frequency (RF) stage,
based on the first power and the channel information, generate a second precoding matrix,
based on the second precoding matrix, calculate a second transmission rate,
in case that the first transmission rate is greater than or equal to the second transmission rate, generate, based on the first precoding matrix, a first signal corresponding to signals to be transmitted through multiple antennas of the base station, and
transmit the first signal through the multiple antennas.

10. The base station of claim 9, wherein the instructions, when executed by the at least one processor individually or collectively, further cause the base station to:
in case that the first transmission rate is smaller than the second transmission rate, calculate, based on the second precoding matrix, second power corresponding to the input power of the RF stage;
based on the second power, generate a third precoding matrix;
based on the third precoding matrix, calculate a third transmission rate;
in case that the second transmission rate is greater than or equal to the third transmission rate, generate, based on the second precoding matrix, a second signal corresponding to signals to be transmitted through the multiple antennas of the base station; and
transmit the second signal through the multiple antennas.

11. The base station of claim 9,
wherein the channel information is information on channels between the multiple antennas and multiple reception antennas of the one or more terminals,
wherein each of the multiple reception antennas uses any one of the one or more numerologies, and
wherein the first precoding matrix is based on a first RF beamformer and a first baseband beamformer.

12. The base station of claim 11,
wherein the first RF beamformer is determined based on f^{(p)} included in Equation a expressed below:
$${f}^{( p )} = \frac{1}{\sqrt{{M}_{t}}} {e}^{( 1 j ∠ ( {A}^{{( {n}_{R F} )}_{{f}^{( p - 1 )}}} ) )} , \qquad Equation a$$
wherein in Equation a, Mₜ indicates a total number of antennas of the base station, function <(a) indicates a function for extracting phases of elements of vector a, n_{RF} indicates a base station RF chain index, and f^{(p)} indicates a beamforming vector for a p^{th} repetition process,
wherein, in Equation a, A⁽ⁿ^{_{RF}}⁾ is expressed as in Equation b below:
$${A}^{( {n}_{R F} )} {=}^{Δ} \{ \begin{matrix}\begin{matrix}( I - {{f}_{R F , {n}_{R F} - 1} ( {f}_{R F , {n}_{R F} - 1} )}^{H} ) {A}^{( {n}_{R F} - 1 )} \\ ( I - {{f}_{R F , {n}_{R F} - 1} ( {f}_{R F , {n}_{R F} - 1} )}^{H} )\end{matrix} , & when {n}_{R F} > 1 \\ {\sum }_{μ = 1}^{M} {\sum }_{k ∈ {𝒦}_{μ}} [ {( {H}_{k}^{( μ )} )}^{H} {\hat{P}}_{k}^{R F} {H}_{k}^{( μ )} ] , & when {n}_{R F} = 1\end{matrix} , \qquad Equation b$$
and
wherein, in Equation b, f_{RF,n}_{_{RF−1}} is indicated through a relationship between F_{RF} and F_{RF}=[f_{RF,1}, f_{RF,2}, . . . , f_{RF,N}_{_{RF}}], F_{RF} is an RF beamformer of a base station, and indicates a matrix in which all components have the same magnitude in a fully connected hybrid beamforming structure, and only values corresponding to a part having an RF chain and an antenna connected therein have the same non-zero value in a partially connected beamforming structure,
$${H}_{k}^{( μ )}$$
indicates a frequency-spatial channel matrix in case that a channel between user k and the base station is indicated by N_{μ} subcarriers (SCs), A^{H} indicates a conjugate transpose of matrix A,
$${\hat{p}}_{k}^{R F}$$
indicates an input power to the RF chain, [symbol] indicates a user set using a μ^{th} numerology, n_{RF} indicates the base station RF chain index, and I indicates a unit matrix.

13. The base station of claim 11,
wherein the first RF beamformer is determined based on f^{(p)} included in Equation c expressed below:
$${f}^{( p )} = \frac{1}{\sqrt{{M}_{t}}} {e}^{( 1 j ∠ ( {\sum }_{μ = 1}^{M} {\sum }_{k ∈ {𝒦}_{μ}} [ {{S}_{{n}_{RF}}^{T} ( {H}_{k}^{( μ )} )}^{H} {\hat{P}}_{k}^{RF} {H}_{k}^{( μ )} {S}_{{n}_{RF}} ] {f}^{( p - 1 )} ) )} , \qquad Equation c$$
wherein, in Equation c, Mₜ indicates a total number of antennas of a base station, Sₙ_{_{RF}} indicates a matrix that expresses a connection between an n_{RFth} RF chain and an antenna,
$${H}_{k}^{( μ )}$$
indicates a frequency-spatial channel matrix in case that a channel between user k and the base station is indicated by N_{μ} subcarriers (SCs), A^{H} indicates a conjugate transpose of matrix A,
$${\hat{p}}_{k}^{R F}$$
indicates an input power to the RF chain, [symbol] indicates a user set using a μ^{th} numerology, and n_{RF} indicates the base station RE chain index,
wherein, in Equation c above, an (i,j)^{th} element of Sₙ_{_{RF}} is expressed as in Equation d below:
$$\begin{matrix}( 27 ) & \\ {S}_{{n}_{R F}} ( i , j ) = \{ \begin{matrix}1 , & if i ∈ {𝒮}_{{n}_{RF}} and i is the j - th smallest number in {𝒮}_{{n}_{RF}} \\ 0 , & otherwise\end{matrix} , & Equation d\end{matrix}$$
and
wherein, in Equation d above, [symbol] indicates an antenna index set connected to an n_{RF}^{th} RF chain.

14. The base station of claim 9,
wherein the first precoding matrix is generated to reduce interference occurring in a signal received by a first terminal group using one numerology among the one or more numerologies, and
wherein the first precoding matrix is generated to reduce interference occurring in a signal received by a second terminal group using a numerology other than the one numerology among the one or more numerologies.

15. The base station of claim 9,
wherein the first power is expressed as in Equation e below:
$${\hat{p}}_{k , {n}_{μ}}^{R F} = {\sum }_{n = 1}^{{N}_{1} / {N}_{μ}} {\hat{p}}_{k , n , {n}_{μ}}^{R F} = {\sum }_{n = 1}^{{N}_{1} / {N}_{μ}} \frac{{‖ {f}_{BB , {n}_{μ} , k}^{( μ )} ‖}_{2}^{2}}{{‖ {F}_{R F} {f}_{BB , {n}_{μ} , k}^{( μ )} ‖}_{2}^{2}} {p}_{{n}_{μ} , k}^{( μ , n )} , \qquad Equation e$$
wherein, in Equation e, F_{RF} is an RF beamformer of a base station, and indicates a matrix in which all components have the same magnitude in a fully connected hybrid beamforming structure, and only values corresponding to a part having an RF chain and an antenna connected therein have the same non-zero value in a partially connected beamforming structure,
$${f}_{BB , {n}_{μ} , k}^{( μ )}$$
indicates a baseband beamforming vector designed to transmit data
$${s}_{{n}_{μ}}^{( μ , n )} [ k ] , {s}_{{n}_{μ}}^{( μ , n )}$$
indicates a data stream vector of an n_{μ}th subcarrier (SC) within an nth orthogonal frequency division multiplexing (OFDM) symbol of a μth numerology,
$${p}_{{n}_{μ} , k}^{( μ , n )}$$
indicates a signal power allocated to the n_{μ}^{th} SC within the nth OFDM symbol of μth numerology for user k, and ∥a∥₂ indicates a Euclidean norm of vector a.

16. One or more non-transitory computer-readable storage media storing one or more computer programs including computer-executable instructions that, when executed by one or more processors of a base station individually or collectively, cause the base station to perform operations, the operations comprising:
acquiring, by the base station, channel information from one or more terminals using one or more numerologies;
based on the channel information, generating, by the base station, a first precoding matrix for the one or more terminals;
based on the first precoding matrix, calculating, by the base station, a first transmission rate;
based on the first precoding matrix, calculating, by the base station, first power corresponding to input power of a radio frequency (RF) stage;
based on the first power and the channel information, generating, by the base station, a second precoding matrix;
based on the second precoding matrix, calculating, by the base station, a second transmission rate;
in case that the first transmission rate is greater than or equal to the second transmission rate, generating, by the base station based on the first precoding matrix, a first signal corresponding to signals to be transmitted through multiple antennas of the base station; and
transmitting, by the base station, the first signal through the multiple antennas.

17. The one or more non-transitory computer-readable storage media of claim 16, the operations further comprising:
in case that the first transmission rate is smaller than the second transmission rate, calculating, by the base station based on the second precoding matrix, second power corresponding to the input power of the RF stage;
based on the second power, generating, by the base station, a third precoding matrix;
based on the third precoding matrix, calculating, by the base station, a third transmission rate;
in case that the second transmission rate is greater than or equal to the third transmission rate, generating, by the base station based on the second precoding matrix, a second signal corresponding to signals to be transmitted through the multiple antennas of the base station; and
transmitting, by the base station, the second signal through the multiple antennas.

18. The one or more non-transitory computer-readable storage media of claim 16,
wherein the channel information includes information on channels between the multiple antennas and multiple reception antennas of the one or more terminals, and
wherein each of the multiple reception antennas uses any one of the one or more numerologies.

19. The one or more non-transitory computer-readable storage media of claim 16, wherein the first precoding matrix is based on a first RF beamformer and a first baseband beamformer.

20. The one or more non-transitory computer-readable storage media of claim 19,
wherein the first RF beamformer is determined based on f^{(p)} included in Equation a expressed below:
$${f}^{( p )} = \frac{1}{\sqrt{{M}_{t}}} {e}^{( 1 j ∠ ( {A}^{{( {n}_{R F} )}_{{f}^{( p - 1 )}}} ) )} , \qquad Equation a$$
wherein, in Equation a, Mₜ indicates a total number of antennas of the base station, function <(a) indicates a function for extracting phases of elements of vector a, n_{RF} indicates a base station RF chain index, and f^{(p)} indicates a beamforming vector for a p^{th} repetition process,
wherein, in Equation a above, A⁽ⁿ^{_{RF}}⁾ is expressed as in Equation b below:
$${A}^{( {n}_{R F} )} {=}^{Δ} \{ \begin{matrix}\begin{matrix}( I - {{f}_{R F , {n}_{R F} - 1} ( {f}_{R F , {n}_{R F} - 1} )}^{H} ) {A}^{( {n}_{R F} - 1 )} \\ ( I - {{f}_{R F , {n}_{R F} - 1} ( {f}_{R F , {n}_{R F} - 1} )}^{H} )\end{matrix} , & when {n}_{R F} > 1 \\ {\sum }_{μ = 1}^{M} {\sum }_{k ∈ {𝒦}_{μ}} [ {( {H}_{k}^{( μ )} )}^{H} {\hat{P}}_{k}^{R F} {H}_{k}^{( μ )} ] , & when {n}_{R F} = 1\end{matrix} , \qquad Equation b$$
and
wherein, in Equation b, f_{RF,n}_{_{RF−1}} is indicated through a relationship between F_{RF} and F_{RF}=[f_{RF,1}, f_{RF,2}, . . . , f_{F,N}_{_{RF}}], F_{RF} is an RF beamformer of a base station, and indicates a matrix in which all components have the same magnitude in a fully connected hybrid beamforming structure, and only values corresponding to a part having an RF chain and an antenna connected therein have the same non-zero value in a partially connected beamforming structure,
$${H}_{k}^{( μ )}$$
indicates a frequency-spatial channel matrix in case that a channel between user k and the base station is indicated by N_{μ} subcarriers (SCs), A^{H} indicates a conjugate transpose of matrix A,
$${\hat{p}}_{k}^{R F}$$
indicates an input power to the RF chain, [symbol] indicates a user set using a μ^{th} numerology, n_{RF} indicates the base station RF chain index, and I indicates a unit matrix.
